(19) United States
(12) Patent Application Publication
(10) Pub. No.: US 2022/0055657 A1
(43) Pub. Date: Feb. 24, 2022

(54) SYSTEM AND METHOD TO ENHANCE AUTONOMOUS VEHICLE OPERATIONS

(71) Applicant: Gordon David McIntosh, Austin, TX (US)

(72) Inventor: Gordon David McIntosh, Austin, TX (US)

(73) Assignee: ITSEC Analytics PTE. LTD., Singapore (SG)

(21) Appl. No.: 17/506,631

(22) Filed: Oct. 20, 2021

Related U.S. Application Data
(63) Continuation-in-part of application No. 16/244,092, filed on Jan. 9, 2019, now Pat. No. 11,027,697.
(60) Provisional application No. 63/104,516, filed on Oct. 23, 2020.
(60) Provisional application No. 63/137,753, filed on Jan. 15, 2021.

(51) Int. Cl. B60W 60/00; G06N 3/02; G06F 9/455

(52) U.S. Cl. CPC B60W 60/001; G06N 3/02; G06F 2009/4557; G06F 2009/45595; G06F 9/45558

(57) ABSTRACT

Methods and systems for implementing enhanced autonomous vehicle features. The present invention details an effective and secure methodology to implement the external management and control of autonomous vehicles by authorized personnel specifically allowing the restriction, management, and/or shutdown of an AV or other mechanism that employ non-deterministic artificial intelligence (AI) algorithms.

### CROSS-REFERENCE TO RELATED APPLICATIONS

This is continuation in part application, claiming priority to U.S. patent application Ser. No. 17/026,227, filed Oct. 20, 2020, U.S. Provisional Application No. 63/104,516, filed Oct. 23, 2020, and U.S. Provisional Application No. 63/137,753, filed Jan. 15, 2021, to U.S. patent application Ser. No. 16/244,092, filed Aug. 1, 2019, now U.S. Pat. No. 11,027,697, which claims priority to U.S. Provisional Application No. 62/710,221, filed Feb. 14, 2018, and U.S. Provisional Application No. 62/762,453, filed May 7, 2018, the disclosures of which are incorporated by reference herein in their entirety.

### TECHNICAL FIELD

The present invention relates generally to an improved data processing system and in particular for enhancing the operation of a mechanism (e.g., autonomous vehicle) controlled by Artificial Intelligence (AI) algorithms. Still more particularly, the present invention provides a system, and method that allows external control of said mechanism by an authorized entity, specifically allowing the restriction, management, and/or shutdown of the mechanism.

### BACKGROUND OF THE INVENTION

The field of AI control of autonomous vehicles and other mechanisms is currently emerging as a promising technology that can reduce costs, reduce accidents and loss of life, reduce insurance premiums, increase productivity for workers and potentially eliminate drunk driving and the associated losses; however, the promise of complete autonomy is based on massive advances in artificial intelligence (AI) and sensor design, both yet to be realized. Manufacturers routinely promise that AI software based on neural networks will mimic the human mind, able to “learn” better skills as they work. Unfortunately, AI software is extremely complex, where machine learning is a sub-field of artificial intelligence, deep learning is a sub-field of machine learning, and neural networks make up the backbone of deep learning algorithms. The amount of software required to even attempt AI is very large, typically hundreds of millions of lines of code. Most importantly, AI algorithms are stochastic, a processes having a random probability distribution or pattern that may be analyzed statistically but may not be predicted precisely, whereas a deterministic process is a process in which no randomness is involved in the development of future states. A deterministic model will thus always produce the same output from a given starting condition or initial state. Obviously, a system that “learns” is constantly changing, therefore cannot be deterministic. Conversely, a deterministic system cannot cope with the complexity AI systems are possible; however, and more importantly, a deterministic system is ideally suited establish, monitor, and enforce a performance envelope for an AI system to mitigate or prevent misuse.

Currently, there is not a single manufacturer of Autonomous Vehicles (AVs) that can respond properly to a simple emergency light or siren, which clearly inhibits law enforcement's ability to carry out lawful interdiction of an AV. Moreover, the fifty (50) potential manufacturers of AVs and hundreds of so potential developers of other AI controlled mechanisms have very disparate capabilities to meet these challenges. In addition, recent misuse of vehicles by terrorists demands that the technology be proactive to develop a comprehensive threat model, as well as mitigation and prevention methodologies rather than reacting to the consequences. Current research into AI image recognition algorithms demonstrates an AI can be easily fooled to misinterpret visual images, i.e., making alterations to inputs in the form of tiny changes that are typically imperceptible to humans can confuse the best neural networks.

Because AI control technology is a recent development, there are currently few commercially available AI controlled mechanisms such as AVs available for sale worldwide, however, the very nature of an AI controlled mechanism provides a large measure of anonymity and therefore the possibility of subsequent misuse. Additionally, a majority of the AVs under development are electric AVs that are much easier to drive and therefore will provide a larger potential for misuse. Misuse can be intentional as in the case of transport of illegal cargo, or misuse by criminals or terrorists; however, misuse can be caused by AI software algorithm failure, AI image misinterpretation, Automatic Driving System (ADS) failure or ADS sensor failure, environmental conditions that interfere with sensor operations, obscured signage, occupant medical issues, failure of mechanisms to secure vehicle loads, or third party misuse such as skitching or hooky bobbing. In some cases, traffic complexity may contribute, e.g., a 5-way or 6-way intersection may have confusing traffic lights that cause the AI misinterpret the traffic signal. An additional type of misuse is the lack of AV automation to deal with real world situations that were taken for granted with human driven automobiles, i.e., the vehicle is no longer usable in certain situations. Although manufacturers make many promises, there will be many situations where a “fully autonomous” vehicle cannot navigate, forcing the occupants find alternative means. One such promise is that AVs can drop off passengers and later pick up same for work, shopping, recreation or other reasons. Obviously, the AV needs to locate compatible parking while it is waiting (and possibly refuel/recharge). In urban areas, this leads to dealing with high capacity parking structures where GPS navigation is impossible, payment methods variable, vehicle density high, spacing limited, complex traffic patterns, variable drop-off and pick-up zones, up-ramps and down-ramps that require specific traffic patterns, parking spots limited so multiple AVs are required to compete, as well as any other of a multitude of real-world problems yet to be discovered.

Autonomous vehicles are categorized by the Society of Automotive Engineers (SAE) in specification J3016, Autonomy Levels 0-5. At Level 2 and above, the driver has relinquished control to the Automated Driving System (ADS) at least temporarily. After a driver has relinquished control, an occupant could possibly have an incapacitating medical event and if no external stimulus can provide access to the vehicle, the occupant may not receive medical treatment promptly. As the level of autonomy increases, there are many additional factors that demand the development of a comprehensive policy and threat model, as well as mitigation and prevention methodologies. The policies and methodologies must meet all regulatory requirements for all jurisdictions where the AV is operated as the industry is subject to many additional rules and regulations such as required by the U.S. Federal Motor Carrier Safety Administration (FMCSA) e.g., Federal Motor Carrier Safety Regulations (FMCSRs).

All vehicles operating at SAE Level 2 autonomy or greater and classified between Class 2-Class 13 by the Federal Highway Administration are subject to misuse and will benefit from this disclosure.

This disclosure is useful for any AI controlled mechanism, however it is particularly important for AVs because of their rapid emergence. In particular, commercial vehicles will benefit from very large cost savings if the driver is replaced by an AI control system, which will accelerate deployment. Because the commercial vehicle market segment is heavily regulated and in the normal course of business, commercial trucks are frequently required to stop for various inspections; in transit, intrastate weigh stations, border weigh stations, agricultural inspection stations, etc. Additionally, law enforcement is frequently required to pull these vehicles over (lawfully stop) to issue violations for overweight loads, safety violations, or to alert the driver there are issues with vehicle or load. Currently, ADS technology cannot hope to cope with the demands put on these vehicles. Additionally, there are other emergency vehicles that require vehicular traffic yield right-of-way, e.g., fire trucks, ambulances, rescue, and hazardous materials vehicles.

It is clear that at AV Level 2 and above, where all control has been relinquished to the AV, there is the need for an authorized entity being able to stop and search (inspect), i.e., Lawful Stop and Search (LSS) The authorized entities are limited to the vehicle owner/operator while in terminal or maintenance and authorized law enforcement while out of terminal. Additionally, the owner/operator may temporarily authorize third parties control an AV.

Currently there are more than 50 automotive manufacturers operating worldwide exploring entry into this new lucrative market of autonomous vehicles, each having independent hardware and software development teams; this underscores serious issues such as the level of automation advertised as opposed to the level of automation attained, operational compatibility between manufacturers, ability of automation to deal with all real world problems facing drivers, AV ADS control system security, the required use of recognized international standards for software development, required testing methodologies of the AV ADS control system, ADS sensor failures, and ADS control system hardware or software failure.

The Transportation Systems Sector is one of the Nation's sixteen (16) designated critical infrastructure sectors that describes the physical and cyber systems and assets vital to the security of the United States under Presidential Policy Directive 21 (PPD-21). As such, autonomous vehicle will be an increasing part of that sector; however, without secure control systems AVs are likely to be easily compromised by hackers, war fighters, terrorists and others seeking to misuse the technology. Secure control systems require secure development practices including: a secure development environment, secure architectural principles and design practices, proper documentation for maintenance personnel, secure life cycle support, and rigorous testing followed by evaluation by third party experts.

Currently, the trucking industry transports greater than 70% of all freight within the US, over $700 Billion dollars in value. In conventional trucking, manned vehicles (with 2-way radios) provide a measure of operational safety from thieves, whereas AVs have no such protection. A simple stop or detour sign erected by a rogue actor on a deserted stretch of road may signal an AI based controller to stop or misdirect the vehicle, making the contents (and vehicle) vulnerable to theft. Alternatively, a rogue actor could flash red lights and sound a siren to attempt to pull the AV over to facilitate a theft. Clearly there are threats to AVs that are unable to be addressed in conventional means. Currently, the lawful stop of a vehicle depends on the driver's visual verification of law enforcement, i.e., the police vehicle, emergency lights and siren, police uniform and the badge; unfortunately, autonomous vehicles may not have a driver present, therefore there needs to be a different methodology employed. The opportunity to improve these outdated metrics and move to secure methodologies requires that Level 2 and above autonomous vehicles use the best technology available and that was designed to provide law enforcement's identification and authentication, message integrity, message confidentiality, non-repudiation of origin and non-repudiation of receipt.

As those of ordinary skill in the art will understand, an ADS is extremely complex, employing very sophisticated AI software and hardware. Software complexity is exacerbated by the requirement that these systems “learn” as they drive, employing artificial intelligence algorithms that cannot be tested. Moreover, the ADS requires complex environmental sensors like LIDAR, RADAR, camera vision systems, and acoustic proximity sensors that have unproven reliability and are subject to degradation in normal operating conditions, e.g., extreme hot or cold temperatures, dust and wind storms, snow, hail, and ice storms, rain, etc. The introduction of new (radical) technology (meaning AI) will require a period, possibly a long period, to gain public trust and acceptance. There is a clear need for a monitor/override system until AI is fully developed as a proven technology. Having a monitor to accurately record the failure rate coupled with an override system providing protection is an optimal strategy to advance AI technology safely.

As previously stated, there are more than fifty (50) automotive manufacturers targeting the AV market, each with differing capabilities, architectures, designs, and goals; however, public safety and the safety of law enforcement personnel require a single secure interface for law enforcement interdiction. Therefore, all Level 2 and above autonomous vehicles must implement lawful stop and search (LSS) that is independent of the vehicle's controller. Because all computer systems are much more vulnerable to exploit when an attacker has physical control of the device, LSS components must be implemented in an enclosure that provides physical protection. Additionally, handheld LSS components should require user identification and authentication so proper authorization can be determined prior to use.

Presidential Policy Directive 21 (PPD-21) specifies sixteen (16) critical infrastructure sectors whose assets, systems, and networks, whether physical or virtual, are considered so vital to the United States that their incapacitation or destruction would have a debilitating effect on security, national economic security, national public health or safety, or any combination thereof. The Transportation Sector is one of the critical infrastructure sectors consisting of seven key subsectors. One subsector applies to vehicles, specifically, the Highway and Motor Carrier subsector includes trucks, other commercial vehicles, traffic management systems; and cyber systems used for operational management. Clearly, these areas have been targeted as primary markets for autonomous vehicles and therefore need special protections. Additionally, all critical infrastructure sectors are particularly vulnerable to an Electromagnetic Pulse (EMP), an Intentional Electro-magnetic Interference (IEMI) event, or a Geomagnetic Disturbance (GD) therefore the transportation sector should address these threats. It is recognized these threats are difficult to defeat, therefore a mitigation strategy may be required.

It is readily apparent that autonomous vehicles require additional protections from many threats present to this emerging technology; therefore, it would be advantageous to have an improved system and method to prevent autonomous vehicle misuse.

### SUMMARY OF THE INVENTION

A system, according to the present disclosure, for the lawful stop and search (LSS) of an autonomous vehicle (AV) under the control of an automatic driving system (ADS) comprising a LSS override controller, a plurality of LSS external controllers, a plurality of LSS special function controllers, a plurality of LSS audit servers, and and a plurality of LSS special function audit servers.

The LSS components, i.e., LSS override controller, LSS external controllers and LSS audit servers are owned and operated by law enforcement or government entities whereas the LSS special function components, i.e., LSS special function controllers and LSS special function audit servers may be owned and operated by law enforcement, government, or private entities including AV Original Equipment Manufacturers (OEMs).

The LSS override controller additionally includes a communication system with an AV LSS Transducer configured to communicate with the LSS external controllers and LSS special function controllers which are configured to allow an authorized entity remotely send commands or information to the LSS override controller. The LSS override controller is configured to respond to LSS external controller commands and if commanded by an authorized entity, will assert unconditional control over the AV ADS controller and, if necessary, bypass the AV ADS controller to assert unconditional control over the AV steering, braking, drive and/or power systems. The LSS override controller further includes a communication system configured to communicate with a remote vehicle dispatch audit server to preserve and protect usage records. The LSS external controllers further include a communication system configured to communicate with a remote law enforcement dispatch audit server to preserve and protect usage records. Optionally, the LSS special function controllers further include a communication system configured to communicate with a remote audit server to preserve and protect usage records.

According to various embodiments, the override controller is configured to independently monitor the behavior, enforce operational limitations, record audit records of attempts to exceed any operational limitation, and record audit records of hardware or software failures, of an AI-based controller and the controlled mechanism, e.g., and AV ADS controller and AV.

According to various embodiments, the LSS override controller is configured to monitor the health of an AV ADS controller and shutdown the AV in the event an ADS controller malfunction or failure.

According to various embodiments, a LSS external controller comprises one or more of a LSS Controller and LSS special function controller where LSS Controllers include LSS manual controllers, LSS illuminators, and LSS Fences.

LSS special function controllers include LSS special function manual controllers, and LSS special function illuminators. A LSS illuminator comprises one or more of a LSS Handheld illuminator and a LSS vehicle mounted illuminator and where the LSS vehicle mounted illuminator comprises one or more of a LSS Automobile Mounted illuminator (i.e., mounted on any land vehicle) and a LSS helicopter mounted illuminator (i.e., mounted on any airborne vehicle).

The LSS external controllers further comprise a communication system configured to communicate with the LSS override controller, and a separate communication system configured to communicate to a law enforcement dispatch audit server to preserve and protect usage records.

According to various embodiments, a LSS special function illuminator may be configured for use on emergency vehicles to transmit yield right-of-way commands to other vehicles to ensure unobstructed passage. Command parameters include the current position, speed, and intended path of the emergency vehicle.

According to various embodiments, an owner/operator may temporarily allow control of a designated AV to third parties for purposes such as maintenance by issuance of a temporary subordinate certificate.

According to various embodiments, the communication protocol between a LSS override controller, acting as a listener, and a LSS external controller, acting as an initiator, provides secure communications including message confidentiality, message integrity, mutual identification and authentication, reliability, and forward secrecy. Identification and authentication employ Public Key Infrastructure (PKI) X.509 certificates issued by a Certificate Authority (CA). The communication protocol allows multiple initiators request and receive concurrent access to the listener.

According to various embodiments, an AV owned and operated by designated entities such as the U.S. Government may be exempt from certain designated commands that could compromise national security, e.g., “UnlockLoadCompartment”. These vehicles must provide proper identification of exempt status using special X.509 PKI certificates.

According to various embodiments, the communication protocol between a LSS override controller and a LSS external controller may be configured to support a single or multiple signaling modes (multi-mode). Single mode supports one of acoustic, optical, radio frequency (RF), or a direct wired connection for both initiator and listener, i.e., since the initiator selects a signaling mode, the listener must use the same signaling mode to respond. In multi-mode the listener can employ a different signaling mode than the initiator during a part of, or the reminder of a communication session, e.g., the initial connection request made may employ a focused beam of optical energy to enhance target selectivity, whereas responses from the listener may employ a RF signal.

According to various embodiments, a LSS illuminator may select the listener's signaling mode, e.g., the LSS illuminator may transmit an optical signal and require the listener respond with an optical signal, or it may require the listener respond with a RF signal.

According to various embodiments, a LSS illuminator optical signaling mode is configured for manual or automatic beam width adjustment.

According to various embodiments, a LSS vehicle mounted illuminator includes a camera located on the beam boresight axis for tracking and record keeping. The camera supports single image and video modes and selected output is stored as an audit record on the law enforcement audit server. Video may also be displayed on a remote touch panel display located near the driver (pilot). The display can be dedicated or may be integrated into the law enforcement vehicle's display/laptop. In cases where minor vehicle violations are noted by law enforcement, it may be sufficient to photograph the vehicle to support video based evidence for citation. A minor violation may include head light, tail light or turn indicator failure, minor damage, or other violations not requiring the vehicle stop. Electronic citations with evidence may be sent from the law enforcement audit server to the AV owner of record.

According to various embodiments, a LSS vehicle mounted illuminator may be configured for automatic tracking to ensure communication success when movement between the AV and illuminator makes successful manual targeting difficult.

According to various embodiments, the LSS helicopter mounted illuminator automatic tracking employs an image tracking algorithm that identifies moving vehicles within the field of view of the illuminator. Once tracking is locked on the vehicle, the illuminator is directed to that location.

According to various embodiments, the LSS helicopter Mounted illuminator automatic tracking employing an optical tracking algorithm that identifies and tracks a optical tracking strobe emitted from a AV LSS Transducer attached to the AV.

According to various embodiments, the LSS vehicle mounted illuminator may employ the LSS Protocol (a modified Point to Point protocol (PPP)), or a Peer-to-Peer (PTP) communication technology such as Vehicle-to-Vehicle (V2V), Vehicle-to-Infrastructure (V2I), or other comparable technologies to obtain the location and unique identifier of all autonomous vehicles within a specified range, heading, and/or path and displays a map of the autonomous vehicles relative to the law enforcement vehicle.

According to various embodiments, a LSS vehicle mounted illuminator may be configured to notify oncoming AVs a roadway is closed due to emergency conditions such as a flash flood or a unstable roadbed.

According to various embodiments, a LSS illuminator employs a visible light pointing aid, consisting of a concentrated center beam on the axis of a diffuse visible light cone approximating the half (M) power beam width of the directed RF signal.

According to various embodiments, a LSS illuminator employs a visible light pointing aid, where the diffuse visible light cone has an adjustable angle that is controlled by the LSS illuminator operator. The operator selection are fixed at approximating the half (M) power beam width of the directed RF signal, manually adjustable, and automatically adjusted. In automatic adjustment mode, the cone angle starts at maximum and automatically is reduced to zero, concentric around the center axis of the LSS illuminator.

According to various embodiments, LSS external controllers of differing types are integrated into a single physical enclosure, e.g., a LSS Vehicle illuminator and a LSS manual controller, a LSS Handheld illuminator and a LSS manual controller, and a LSS helicopter mounted illuminator and a LSS manual controller.

According to various embodiments, LSS special function controllers comprise one or more of LSS special function illuminators and LSS special function manual controllers each having authority to communicate with the LSS override controller but limited to specific situations and/or geographical locations. LSS special function illuminators comprise LSS emergency vehicle controllers and LSS location controllers. LSS special function manual controllers comprise LSS terminal controllers and LSS maintenance controllers.

According to various embodiments, LSS special function controllers of differing types may be integrated into a single physical enclosure, e.g., a terminal controller and a maintenance controller.

According to various embodiments, the LSS System may be configurable for all autonomous vehicles (AV) operating at Level 2 autonomy or greater as defined by the Society of Automotive Engineers (SAE) specification J3016 and classified between Class 2-Class 13 by the Federal Highway Administration (FHA). This includes commercial autonomous trucks classified by the U.S. Department of Transportation (DOT) between Class 1 and Class 8.

According to various embodiments, the LSS System is configurable for commercial and non-commercial vehicles operating on public roadways under law enforcement jurisdiction, operating on private property or roadways under control of owner/operators, operating on private maintenance facilities, or operating on U.S. Federal property and roadways, e.g., military installations.

According to various embodiments, the LSS override controller, LSS external controllers may be housed in enclosures that provide protection of internal memory, including one or more of evidence of tampering, physical security mechanisms, or physical security mechanisms providing a complete envelope of protection around the enclosure with the intent of detecting and responding to all unauthorized attempts at physical access.

According to various embodiments, the LSS override controller, AV ADS controller, associated sensors, LSS external controllers may be housed in enclosures that defeat or mitigate the threat of an ElectroMagnetic Pulse (EMP), an Intentional ElectroMagnetic Interference (IEMI) event, or a Geomagnetic Disturbance (GD).

According to various embodiments, the LSS override controller includes a smart card reader interface and supporting software for those environments where a smart card is necessary to support the multi-factor authentication required for administrative access to a LSS override controller; including software updates, password management, certificate management, and/or extended testing, The smart card reader interface may be configured to support local or remote smart card readers.

According to various embodiments, the software updates the for LSS override controller, LSS external controllers and audit servers must be obtained via secure channel employing mutual authentication, have verified cryptographic hashes and digital signatures employing FIPS approved algorithms.

According to various embodiments, the LSS override controller, LSS external controllers may be configured to use the Network Time Protocol (NTP) to timestamp all records.

According to various embodiments, the LSS override controller and LSS external controllers require NTP listeners that meet RFC5906 Autokey specification.

According to various embodiments, the LSS override controller and LSS external controller software updates are performed by authorized personnel in a secure facility.

According to various embodiments, the LSS external controllers includes a smart card reader and supporting software in those environments where a smart card is necessary to support the multi-factor authentication required to use a LSS external controller.

According to various embodiments, the LSS override controller is logically and physically distinct and independent from the AV ADS controller and may assert unconditional control over the AV ADS Controller, and may bypass the AV ADS controller to assert unconditional control over the vehicle steering, braking, drive and power systems.

According to various embodiments, the LSS override controller is logically distinct from the AV ADS controller.

According to various embodiment, the LSS override controller is logically and physically indistinct from the AV ADS controller.

According to various embodiments, the LSS override controller is configured to monitor AV speed as specified in the current route speed embedded in route map.

According to various embodiments, LSS System software is deterministic, therefore will always produce the same output from a given starting condition or initial state.

According to various embodiments, LSS is a deterministic system, configured to independently monitor the behavior, enforce operational limitations, record attempts to exceed any operational limitation, and record hardware or software failures, of an AI based control system.

According to various embodiments, LSS Components implement disk encryption with strong external keys, implementing a key hierarchy consisting of the “Key Encryption Key” (KEK), used for the encryption of the “Disk encryption key” (DEK). The DEK is used for the encryption/decryption of the user data partition of the device.

Embodiments according to the present disclosure provide a number of advantages. As a first example, the present disclosure provides a system and method by which an autonomous vehicle under AV ADS control and traveling on public roadways may be stopped, inspected, and maneuvered only by authorized law enforcement personnel. As a second example, the present disclosure provides a system and method by which a disabled autonomous vehicle on public or private roadways may be maneuvered by authorized maintenance or law enforcement personnel. As a third example, the present disclosure provides a system and method by which an autonomous vehicle under ADS control on private property or roadways may be maneuvered by authorized terminal or maintenance personnel. As a fourth example, the present disclosure provides a system and method by which a Department of Defense (DOD) or Federal autonomous vehicle under ADS control traveling on DOD or other Federal property or roadways may be stopped, inspected, and maneuvered only by authorized DOD or authorized federal personnel. In each of the four cited examples, the autonomous vehicle may be stopped, inspected and maneuvered even in the event of ADS malfunction or complete failure.

### BRIEF DESCRIPTION OF THE DRAWINGS

The novel features believed characteristic of the invention are set forth in the appended claims; however, the invention itself, as well as a preferred mode of use, further objectives and advantages thereof, will best be understood by reference to the following detailed description of an illustrative embodiment when read in conjunction with the accompanying drawings, wherein:

FIG. 1 is a block diagram showing a typical Autonomous Vehicle with ADS and Sensor System in which the present invention may be implemented;

FIG. 2 is a block diagram of the preferred embodiment of a Lawful Stop and Search (LSS) System showing LSS components and relationships;

FIG. 3 depicts an embodiment of a handheld Lawful Stop and Search (LSS) illuminator;

FIG. 4 depicts an embodiment of a LSS automobile mounted illuminator;

FIG. 5 depicts an embodiment of a LSS helicopter mounted illuminator;

FIG. 6 is a diagram depicting a use case for a LSS Fence;

FIG. 7 is a block diagram of a LSS override controller, a AV ADS controller and AV Systems, and AV sensors showing interrelationships and ADS Control Interfaces;

FIG. 8 is a block diagram of an embodiment of a LSS override controller electronic components;

FIG. 9 is a diagram illustrating an Integrated Directional Optical and Omnidirectional RF AV LSS Transducer;

FIG. 10 is a diagram illustrating two views of an Integrated Omnidirectional Optical and RF AV LSS Transducer;

FIG. 11 is a block diagram depicting a typical Autonomous Vehicle (AV) automatic driving system (ADS) Controller and AV Systems;

FIG. 12 is a block diagram of a LSS Handheld illuminator electronic components;

FIG. 13 is a block diagram illustrating components of a LSS vehicle mounted illuminator;

FIG. 14 is a diagram depicting an aerial view of a traffic pattern on a typical roadway with a law enforcement vehicle;

FIG. 15 depicts a touch panel display with controls and indicators showing a LSS camera view of the adjacent vehicles in relation to a law enforcement vehicle;

FIG. 16 depicts a touch panel display with controls and indicators showing a LSS illuminator camera view of the adjacent vehicles in relation to a law enforcement vehicle and targeting of one vehicle's LSS transducer with focused optical beam;

FIG. 17 depicts a touch panel display with controls and indicators showing a LSS illuminator camera view of the adjacent vehicles in relation to a law enforcement vehicle with command menus displayed;

FIG. 18 depicts a touch panel display with controls and indicators showing an aerial map of autonomous vehicles in the field of view of a helicopter employing a LSS helicopter mounted illuminator;

FIG. 19 depicts a touch panel display with controls and indicators showing an aerial map of autonomous vehicles in the field of view of a helicopter employing LSS helicopter mounted illuminator tracking a selected vehicle;

FIG. 20 depicts a touch panel display with controls and indicators showing an aerial map of autonomous vehicles in the field of view of a helicopter employing LSS helicopter mounted illuminator tracking a selected vehicle with command menus displayed;

FIG. 21 is a block diagram illustrating the electronic components of a LSS Fence;

FIG. 22 is a block diagram illustrating the electronic components of a LSS manual controller;

FIG. 23 is a diagram of a LSS Integrated illuminator and manual controller showing controls and beam patterns;

FIG. 24 is a diagram depicting the optical, RF, and acoustic beam patterns of a LSS Handheld illuminator;

FIG. 25 is a diagram depicting two views of a LSS illuminator Pointing-Aid showing the center spot and surrounding cone;

FIG. 26 is a block diagram showing a typical highway with vehicular traffic and an emergency vehicle requiring right of way.

FIG. 27 is a block diagram showing a preferred embodiment of PKI Certificate Distribution.

FIG. 28 is a diagram depicting the LSS Protocol Stack

FIG. 29 is a diagram depicting LSS modified point-to-point protocol over Xmedia (MPPPoX) Discovery (MPPPoXD).

FIG. 30 is a block diagram showing an override controller configured to independently monitor the behavior, enforce operational limitations, record audit records of attempts to exceed any operational limitation, and record audit records of hardware or software failures of the AI-based controller and controlled mechanism;

FIG. 31 is a block diagram of an AI-based system operating within an isolated operating environment with hypervisor-based monitor and control.

### DETAILED DESCRIPTION OF THE INVENTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

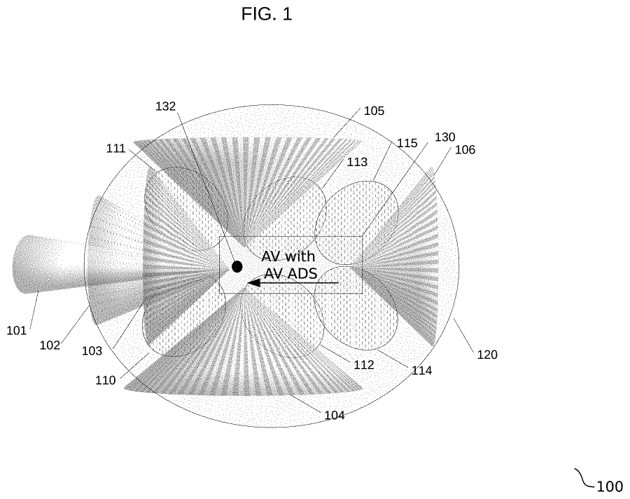

Referring now to FIG. 1, a block diagram depicting a typical Autonomous Vehicle (AV) with AV ADS controller and Sensor System 100 in which the present invention may be implemented. Those of ordinary skill in the art will appreciate that the AV ADS controller and the Sensor System 100 may vary according to the manufacturer, design requirements, requirements sew mandated by local and federal regulatory bodies, as well as intended usage. Depicted in FIG. 1 is an AV with AV ADS controller 130 and the various sensors currently being designed for autonomous vehicles; direction of forward travel is indicated by arrow. These diagrams show forward long range radar sensor coverage 101, side medium radar coverage 104 and 105, and rear medium range coverage 106, camera coverage 102, short forward range radar coverage 103, acoustic sensor coverage 110, 111, 112, 113,114, and 115, and omnidirectional sensor coverage pattern 120 sensed by the omnidirectional sensor 132. The omnidirectional sensor may represent a GPS/GNSS, LIDAR, V2X, LSS, RF, or a combination of these (or other technology types). i.e., an AV could support multiple omnidirectional technologies each having dedicated sensors, or sensors integrated with multiple technologies. A LSS (Lawful Stop and Search) transducer, either dedicated or integrated with other sensor technology may be implemented as a single signaling mode or as a multi-mode transducer as design demands. Typical modes include: light emitting diode (LED), visible laser, infrared laser, acoustic, radio frequency (RF) and/or other applicable technologies; multi-mode devices would utilize two or more of these (or two or more frequencies), either selectably or automatically.

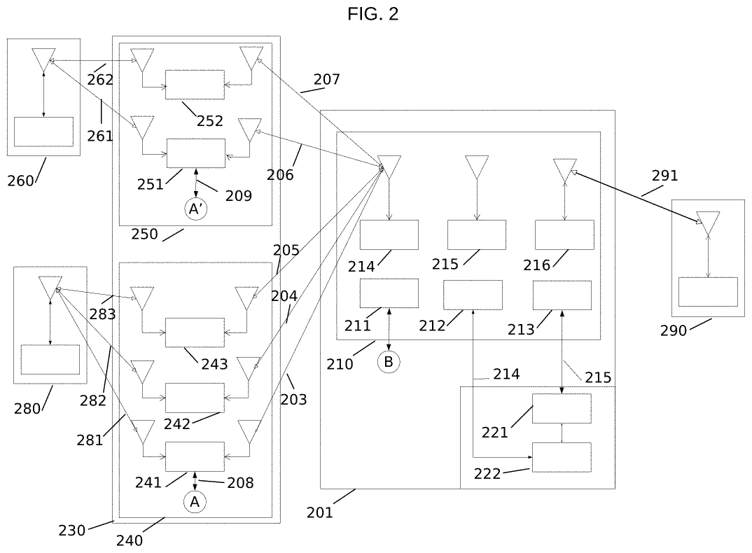

Referring now to FIG. 2, a block diagram depicting a typical Autonomous Vehicle (AV) 201 with AV ADS controller 221 and Sensor System 222 in which the present invention may be implemented. The preferred embodiment of the present invention comprising LSS components, LSS supporting components, and communication paths between the components. LSS Components comprise a LSS override controller 210, LSS external controllers 230. LSS supporting components comprise the Law enforcement dispatch audit server 280, vehicle dispatch audit server 290, and LSS special function audit server 260. The AV ADS, AV Systems 222 and LSS override controller 210, are internal to the autonomous vehicle 201 whereas the LSS external controllers 230, law enforcement dispatch audit server 280, vehicle dispatch audit server 290, and LSS special function audit server 260 are remotely located.

The AV ADS controller 221 employs an artificial Intelligence (AI) based control system to interpret the inputs from the AV sensors to independently navigate the AV 201 under all roadway and environmental conditions at any time a driver is not present, or when the driver has relinquished control to the ADS. The AV ADS controller 221 also supports a communication interface 215 directly from the LSS override Controller 210 that allows commands, responses and information transfer between the LSS override controller 210 and ADS 221. Commands are intended to allow override of ADS control in situations an AI-based controller cannot adequately make decisions based solely on the interpretation of sensor data. Information may be considered any additional data source (e.g., route map updates) as well as heartbeat signals from the ADS to the override controller.

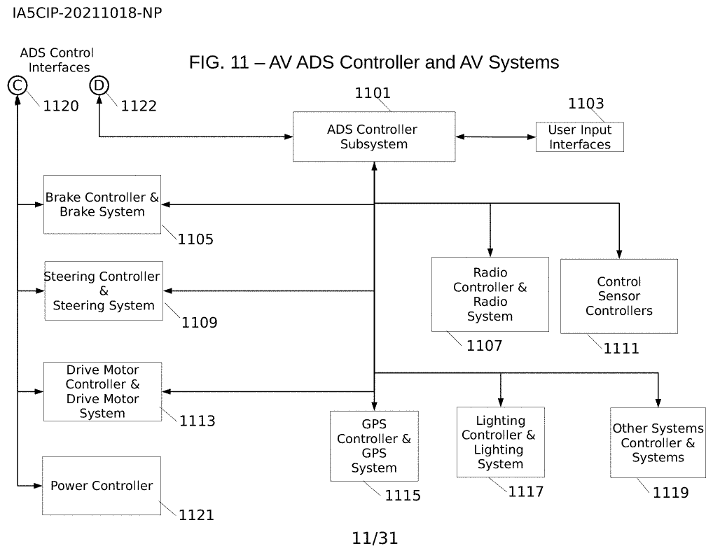

AV systems 222 includes all control components necessary to maneuver and navigate the AV 201. Typical components are detailed in FIG. 11. AV Systems 222 also supports an emergency control interface 214 form the LSS override Controller 210 that may override any signal from the ADS to the Brake Controller & Brake System, Steering Controller & Steering System, Drive Motor Controller & Drive Motor System, and Power Controller.

The LSS override controller 210 supports a plurality of interfaces including a External Control Interface 211, a Emergency Override Interface 212, a AV ADS Control Interface 213, a LSS Transducer 214, a GPS Receiver Interface 215, and a Network Interface 216. Both the Emergency Override Interface 212 and AV ADS Control Interface 213 may be configurable to interface with various Original Equipment Manufacturer (OEM) ADS designs.

The LSS override controller 210 may be logically and physically independent from the AV ADS controller 221 and the AV Systems 222; it may assert unconditional control over the AV ADS controller 221 via the AV ADS Control Interface 213 upon receipt of an authorized command from a LSS external controller 230. If necessary, the LSS override controller 210 may bypass the AV ADS controller 221 to assert direct control over the vehicle steering, braking, drive and power systems within the AV Systems via the Emergency Override Interface 212 upon receipt of an authorized command or in the event of an AV ADS controller 221 failure. Additionally, the LSS override controller 210 may monitor AV ADS controller 221 heartbeat signals via the AV ADS Control Interface 213.

The LSS override controller 210 is deterministic and may be configured to independently monitor the vehicle steering, braking, and drive systems behavior, enforce operational limitations on the vehicle acceleration, speed, and location, and record attempts to exceed any operational limitation or failures, of an AV ADS controller 221.

LSS external controllers 230 include LSS Controllers 240 and LSS special function controllers 250. LSS Controllers 240 include LSS manual controller 241, LSS illuminator 242, and LSS Fence 243. LSS special function controllers 250 include LSS special function manual controller 251, and LSS special function illuminator 252.

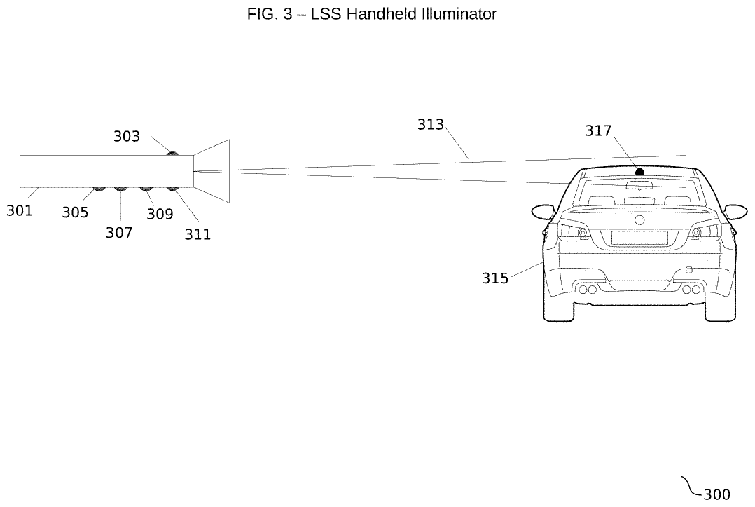

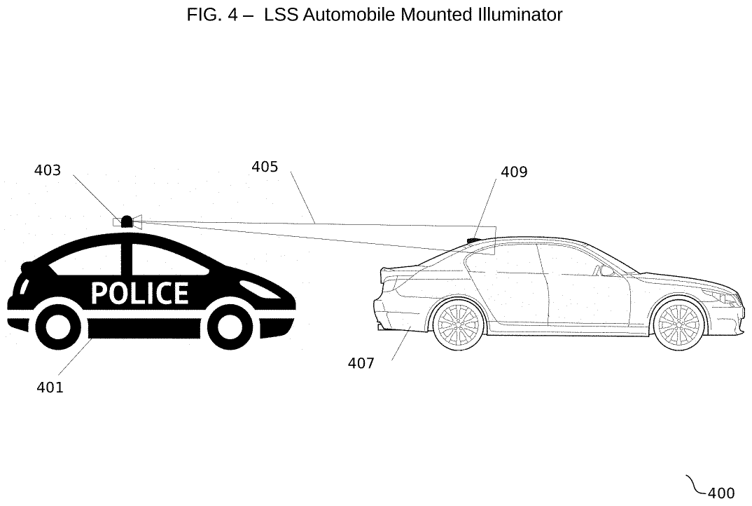

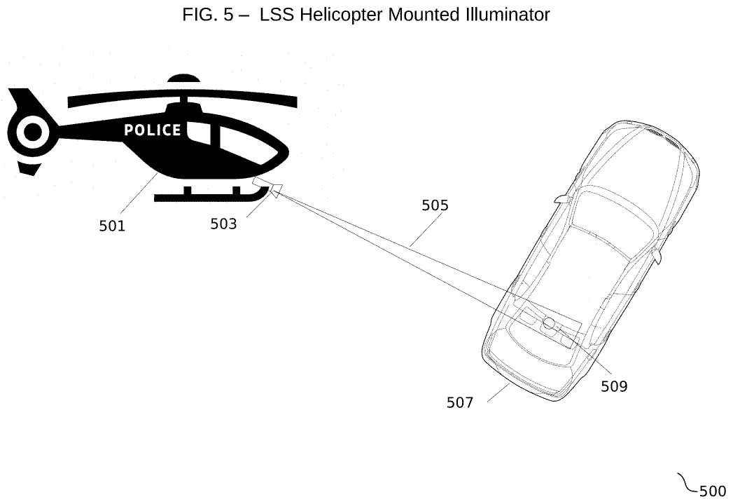

The LSS illuminator 242 may refer to a LSS Handheld illuminator (detailed in FIG. 3), or a LSS vehicle mounted illuminator, which may refer to either a LSS Automobile Mounted illuminator (detailed in FIG. 4), or a LSS helicopter mounted illuminator (detailed in FIG. 5)

Communication paths 203, 204, 205, 206, and 207 between a LSS override controller 210 and LSS external controller 230 employ the LSS Protocol, a modified point-to-point protocol over Xmedia (MPPPoX), where the physical media (Xmedia) may be optical, RF, or acoustic depending on the signaling mode. The output power from the optical, RF, or acoustic emitter may be configured to be constant or a variable controllable output. The communication paths 208, and 209 are direct wired between LSS override controller 210 and LSS external controller 230 and employ the LSS Protocol, a modified point-to-point protocol over Ethernet (MPPPoE) where Ethernet is the physical media.

The LSS protocol employs Federal Information Policy Standards (FIPS) approved algorithms to provide secure connectivity, i.e., message confidentiality, message integrity, mutual identification and authentication, reliability, forward secrecy, and non-repudiation. Identification and authentication employ Public Key Infrastructure (PKI) X.509 certificates issued by a Certificate Authority (CA).

Communication between a LSS external controller 230 and a LSS override controller 210 is separated into stages, including vehicle selection stage, command/response stage, and termination stage. These stages may vary slightly according to the type of LSS external controller. The selection stage obtains a specific AV identifier, or multiple identifiers, for use during command/response stage. The command/response stage transmits operator commands and receives responses from the LSS override controller. When all commands and responses are completed, the termination stage closes the connection.

During the vehicle selection stage by a LSS Handheld illuminator, the target AV LSS Transducer 214 is illuminated by the LSS Handheld illuminator using one of the signaling modes: focused optical beam, focused RF beam, wide RF beam, or acoustic beam. In focused optical beam mode, the beam width is very small and allows focusing and selecting of an individual target vehicle. In focused RF beam mode, the beam width is wider than the optical beam mode, but in sparse traffic conditions, allows focusing and selection of an individual target vehicle; however, multiple vehicles may be selected. In wide RF beam mode, the beam width is much wider than the focused RF beam, and in traffic conditions where only a single vehicle is within range, allows focusing and selection of that target vehicle; however, it is more likely to select multiple vehicles. In acoustic beam mode, the beam is very restricted in range and is appropriate for selecting vehicles that are extremely close. In the case where multiple vehicles are selected with the LSS Handheld Illuminator, all vehicles will receive the same command transmit.

A LSS vehicle mounted illuminator has two additional signaling modes available to map and target an AV; the omnidirectional mode and peer-to-peer modes. In the first, the LSS vehicle mounted illuminator and LSS override controller are configured for a mapping/selection mode using the omnidirectional signaling mode where all vehicles with range are illuminated, transmitting and responding to MPPPoX discovery packets. During MPPPoX discovery and session stages, the vehicle identifier, location and heading of each AV within a specified range is obtained and mapped on a display relative to the law enforcement vehicle. The desired vehicle or vehicles can then be selected and command transmit.

In the second, the peer-to-peer mode, the LSS vehicle mounted illuminator employs a Peer-to-Peer Receiver based on a communication technology such as V2V, or other comparable technologies to obtain the location and unique identifier of all autonomous vehicles within range for display on a map of the autonomous vehicles relative to the law enforcement vehicle. The desired vehicle or vehicles can then be selected and command transmit.

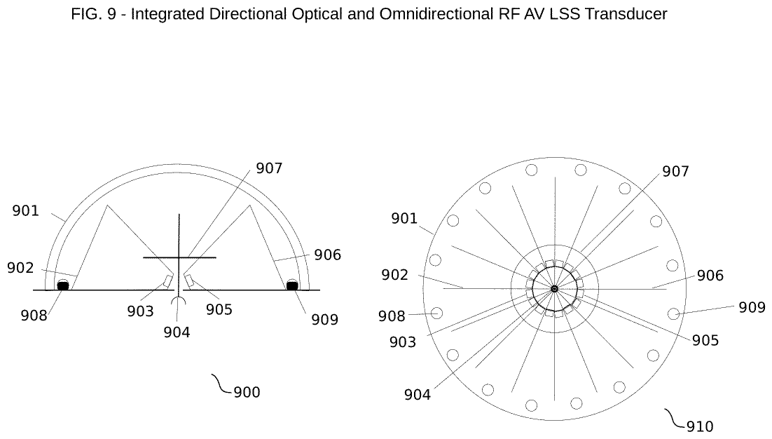

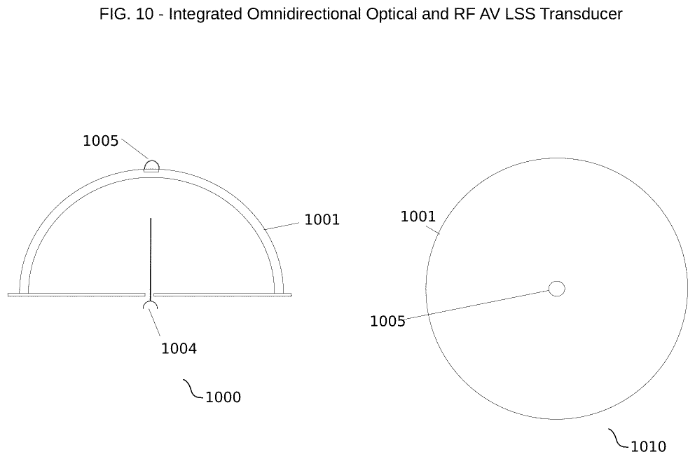

The LSS transducer supports at least one or more of three signaling modes, optical, RF, and/or acoustic. The optical, RF, and acoustic receive and transmit signaling modes may be directional, semi-directional, or omnidirectional, however, the RF mode is omnidirectional in both receive and transmit. The LSS transducer may support an optical tracking strobe which allows a LSS illuminator automatically track the transducer. Additionally, the LSS transducer may support and optical test strobes. The LSS Transducer's optical, RF, and acoustic sensors and transmitters may be integrated into a single enclosure or be separated into multiple enclosures. In the preferred embodiment of the invention, the optical and RF transducers are integrated into a single enclosure and the acoustic transducers in multiple separate enclosures. The LSS transducer is further described in FIG. 9 and FIG. 10.

The communication protocol also supports single or dual signaling modes (dual-mode). Single mode supports one of acoustic, optical, or radio frequency (RF) for both initiator and listener, i.e., since the initiator selects a signaling mode, the listener must use the same signaling mode to respond. In dual-mode the listener can employ a different signaling mode than the initiator during a part of, or the remainder of a communication session, e.g., the initial connection request made by an initiator may employ a focused beam of optical energy to enhance target selectivity, whereas responses from the listener and subsequent transmissions from the initiator may employ a radio frequency (RF) signal.

In an alternate embodiment, since focused RF, wide beam RF or omnidirectional RF signaling modes may illuminate multiple vehicles and all vehicles will respond to the signal, making communication difficult or impossible, the transmit chain is configured for Carrier Sense Multiple Access/Collision Avoidance (CSMA/CA).

In another alternate embodiment, since focused RF, wide beam RF or omnidirectional RF signaling modes may illuminate multiple vehicles and all vehicles will respond to the signal, making communication difficult or impossible, the transmit chain is configured for Discovery Sense Multiple Access/Collision Avoidance (DSMA/CA) for RF signaling modes. DSMA/CA is a modification to CSMA/CA, where DSMA/CA operates at the physical layer and both the carrier and frame content are sensed, in particular, waiting until the MPPPoX Active Discovery Session-confirmation (MPADS) has been transmit.

In another alternate embodiment, since focused RF, wide beam RF or omnidirectional RF signaling modes may illuminate multiple vehicles and all vehicles will respond to the signal, making communication difficult or impossible, therefore, the transmit chain is configured for DSMA/CA for RF signaling modes, where the initiator transmits the current initiator's GPS coordinates, heading, path, and flags in the MPPPoX Active Discovery Initiation (MPADI) packet payload field. Listeners (LSS override controllers) analyze the GPS coordinates, heading, path, and flags to make the decision to respond or not respond. The flags specify if the AV's heading is to be factored and the distance from the initiator that response is required. E.g., the initiator could specify that all AV's traveling in the same direction, within a specified radius must respond.

The TLS protocol is employed at the application layer between a LSS override controller 210 and a LSS external controller 230 and uses multiple stages in communication including: connection, handshake, application, and termination. The connection phase is initiated by a LSS external controller making a connection request. The handshake phase allows the two communicating sides (endpoints) exchange messages including: endpoint acknowledgment, protocol version, mutual identification and authentication, encryption algorithms, session keys, vehicle ID and external controller type and version. During the application phase, data is exchanged between the endpoints. When the application phase is complete, the connection is terminated with each side of the connection terminating independently.

After completion of the handshake, a secure session has started and one of the LSS external controllers 230 can send commands or information to the LSS override controller 210; commands can be used to stop, maneuver or change the route (divert) the AV, information supplies data not otherwise available to the AV. Once the session is completed, the connection is closed.

Communication paths 281, 282 and 283 between a LSS manual controller 241, a LSS illuminator 242, and a LSS Fence 243, acting as network clients, and a law enforcement dispatch audit server 280 (acting as network server) are depicted. These communication paths allow audit records of all LSS transactions be stored securely on the remote law enforcement dispatch audit server 280. Similarly, communication paths 261, and 262 between a LSS special function manual controller 251, and/or a LSS special function illuminator 252, acting as network clients, and a special function audit server 260 (acting as network server) are depicted.

Also depicted is a communication path 291 between a LSS override controller 210 and vehicle dispatch audit server 290 allow all LSS transactions be stored securely on the remote vehicle dispatch audit server 290.

The audit communication paths 281, 282, 283, 251, 252, and 291 employ the Transport Layer Security (TLS) protocol over Transport Control Protocol/Internet Protocol (TCP/IP) to ensure guaranteed delivery. The protocol uses FIPS approved algorithms to provide secure connectivity, i.e., message confidentiality, message integrity, mutual identification and authentication, reliability, forward secrecy, and non-repudiation. Identification and authentication employ PKI X.509 certificates issued by a CA.

The law enforcement dispatch audit server 280, LSS special function audit server 260, and vehicle dispatch audit server 290 are specialized servers that receive, store, protect, and display audit records received from the LSS System. Additionally, audit records may be exported from the audit server with security attributes to provide records for non-repudiation. Audit records also help monitor security-relevant events, and act as a deterrent against security violations. Audit functions include a defined audit record format and audit data protection. The audit record is presented in human-readable format either directly (e.g. storing the audit trail in human-readable format) or indirectly (e.g. using audit reduction tools), or both. Additionally, audit analysis tools, violation alarms, and real-time analysis may be available. Analysis tools allow large volumes of audit records be searched for particular events of interest. A violation alarm can be set to automatically inform an authorized user (of the audit server) that a particular event has occurred, e.g., a alarm could be set to detect when a LSS interdiction has occurred, when a n illegal LSS interdiction has been attempted, or when an AV becomes disabled.

In operation a LSS override controller 210 in an AV traveling on public roadways will first receive input from a LSS illuminator 242, a LSS Fence 243, or LSS special function illuminator 252 to halt the AV. When the AV is halted, the ADS will be disabled by the LSS override controller. The LSS manual controller 241 and LSS special function manual controller 251 require the AV be fully halted with ADS disabled to successfully establish a communication session with the LSS override controller 210.

Authorized law enforcement personnel may use LSS illuminator 242 (a LSS vehicle mounted illuminator or a LSS Handheld illuminator) to send command messages to the LSS override controller 210 to obtain specific information about, or maneuver the AV 201. Command messages are signed and include: vehicle ID, type, command, time, date, and additional parameters specific to each command. The vehicle ID field is a Media Access Control (MAC) address and may be −1 (hexadecimal 0xffffffffffff) to indicate a broadcast address, or contain a valid vehicle ID; if −1, all vehicles receiving a command message respond, if a valid vehicle ID), the specified vehicle responds. The type field identifies the LSS illuminator 242 type, examples are shown in Table 1.

Upon receipt of a command message, the LSS override controller 210 evaluates the command parameters, and if valid, executes the command and responds with a response message specific to each command message. Response messages are signed and include: command execution status, type, time, date, and additional parameters specific to each command.

Command messages from an LSS illuminator are used to obtain specific information about, or to maneuver an AV. Commands available to the LSS Handheld illuminator are information commands including: “Identify” and “Acknowledge” and the maneuver commands including: EmergencyStop”, “Stop”, and “ResumeOperation”. Commands available to a LSS vehicle mounted illuminator are information commands including: “Location”, Identify”, “Acknowledge”, “Status”, “SelfTest”, “Manifest”, “BillOfLading”, “Minor Violation”, and “Violation” and maneuver commands including: “EmergencyStop”, “Stop”, “Slow”, “PullOverPark”, “Yield”, and “ResumeOperation”. Additionally, a LSS vehicle mounted illuminator has the capability to record a video or a single photograph of the current field of view. Recording can be triggered automatically when commands are transmit, or manually at any time. Recording data is stored internally as an audit record and tagged with time, date, and location coordinates; and transmit to the law enforcement audit server for secure storage. Those of ordinary skill in the art will appreciate that design requirements, regulatory requirements, field experience, as well as other factors may require commands be added, modified, and/or removed.

The “Location” command requires the LSS override controller return the current GPS coordinates, compass heading and speed. This command indicates what vehicles are required to respond and is comprised of at least the following fields: distance from LSS illuminator.

The “Identify” command requires the LSS override controller return a unique identifier such as Vehicle Identification Number (VIN) that can be used to uniquely identify a specific AV.

The “acknowledge” command requires the LSS override controller activate a strobe light in the AV LSS Transducer giving visual indication of receipt of command. The strobe light may also acts as a tracking aid, transmitting a known digital signal that can be automatically tracked by a LSS vehicle mounted illuminator.

The “Status” command requires the LSS override controller and ADS status be returned.

The command “SelfTest” requires a self test be performed to verify the health of the LSS override controller and transducers, and return the self test reports.

The command “Manifest” requires the AV respond with the current vehicle cargo manifest data.

The command “BillOfLading” requires the AV respond with the current vehicle cargo bill of lading.

The command “MinorViolation” is issued when a minor violation is discovered that does not cause immediate danger and therefore does not require the AV stop for further inspection or immediate maintenance. The command may include the type of violation and optional photographic or video evidence.

The command “Violation” is issued when a violation is discovered that may cause immediate danger and therefore requires the AV stop for further inspection or immediate maintenance. The command may include the type of violation and optional photographic or video evidence.

The command “EmergencyStop” is issued only when imminent danger necessitates the AV must apply all available means to halt.

The command “Stop” is issued in situations that require the AV slow and halt using normal safety rules.

The command “Slow” command requires the AV reduce speed.

The command “PullOverPark” is intended for normal situations where vehicle inspection e.g., load inspection, vehicle weight, or other lawful stop of the AV requires the AV clear traffic lanes; however, law enforcement may be required to clear traffic from those traffic lanes required to pull over and park.

The command “Yield” requires the AV yield right-of-way to an approaching authorized emergency vehicle.

The command “ResumeOperation” requires the AV continue its preprogrammed route after law enforcement operations have concluded.

Once an AV has been halted by LSS, no AV ADS control may be applied until enabled by receipt of the “ResumeOperation” command. Additionally, some commands require sub-commands for added information, e.g., the “PullOverPark” command could include sub-commands to indicate why the AV was pulled over, e.g., “MobileScale”, “LoadInspection”, “EquipmentViolation”, or others as required.

If necessary, authorized law enforcement personnel may use the LSS illuminator 242 (a LSS vehicle mounted illuminator or a LSS Handheld illuminator) to stop the AV, after which a LSS manual controller 241 may be used to control to the AV. The LSS manual controller 241 may be wireless in which case it communicated to the LSS override controller via communication path 203, or it may be connected directly by wire cable (A to B) via communication path 208. Similarly, a LSS special function manual controller 251 may be connected directly by wire cable (A′ to B) via communication path 209.

Command messages from an LSS manual controller 241 are used to obtain specific information about, maneuver, or perform ancillary tasks. Information commands include: “Identify”, “Acknowledge”, “Status”, “DownloadVehicleIdentification”, “SelfTest”, “Manifest”, and “BillOfLading”; maneuver commands include: the proportional commands, “PullForward”, “BackUp”, “TurnLeft”, and “TurnRight” and the fixed commands, “Stop” and “ResumeOperation”; where the proportional commands carry rate information and are used to move the vehicle locally at low rates of speed. Ancillary commands include: “ContactTerminal”, “UnlockLoadCompartment” and “Train”. Those of ordinary skill in the art will appreciate that design requirements, regulatory requirements, field experience, etc., may require commands be added, modified, and/or removed.

The command “Stop” is issued in situations that require immediate AV halt.

The command “DownloadVehicleIdentification” is intended for situations where vehicle inspection requires the vehicle produce documentation such as: the motor carrier's name or trade name, the motor carrier's Department of Transportation (DOT) registration number, manifest, proof of insurance, maintenance records, accident records, licenses, permits, planned route and actual route, etc.

The command “UnlockLoadCompartment” is used to unlock the vehicle cargo bay so law enforcement may perform vehicle load inspections. An AV owned and operated by designated entities such as the U.S. Government may be exempt from this command to avoid exposing information that may compromise national security; however, these vehicles must provide proper identification of exempt status using special X.509 PKI certificates.

The command “ContactTerminal” is intended to notify the vehicle's owner/operator that additional assistance is required.

The command “Train” is intended to notify the vehicle's AI-based ADS to enter training mode such that the AV's ADS can learn new behaviors. This command may have several sub-commands, e.g., “AddActivity”, “Demonstrate”, “Finalize”, and “VoiceCommand”. The “AddActivity” sub-command enters training mode for a new activity and the manual controller is used to maneuver the vehicle to “teach” the AV ADS the new activity. The “Demonstrate” sub-command is used to allow the AV replicate the learned behavior while still under control of the LSS manual controller. This allows the operator to avoid any problems and correct errors. After demonstrating the new behavior has been adequately learned, the “Finalize” sub-command commits the behavior. A typical example is to teach the AV an unmapped route on a private roadway lacking recognizable signage or other features the AV has been trained. This could be be any activity that is required frequently, such as moving from parking to an electric recharge station or to a refueling station and back. Once in “train-add” mode, a new behavior can be assigned by name after which the AV is maneuvered by the LSS manual controller and each step memorized by the ADS. After “train-add” mode is complete, the “train-demonstrate” mode is entered and the AV attempts to correctly demonstrate the behavior; errors or omissions may be corrected if necessary. Once the behavior is deemed adequate by the training entity, the “train-finalize” mode is entered to finalize. Each training session may result in a custom (named) command being generated and memorized by the AV ADS and made available for execution, or the behavior is simply added to the AV's knowledge base for autonomous operation. Additionally, the “VoiceCommand” sub-command allows an entity to train the AI to recognize a unique individual's voice for commands that maneuver the vehicle, E.g., “PullForward”, “BackUp”, “TurnLeft”, “TurnRight” and “Stop”.

An AV may also encounter a LSS Fence 243 in locations that require the AV recognize a restricted area that the AV may not enter. The LSS Fence issues a single “Fence” command that transmits the GPS coordinates of the restricted location so the AV may reroute. A LSS Fence may be at fixed locations or mobile, able to be moved as required.

An AV may also encounter a LSS special function manual controller 251 (a Terminal controller or a Maintenance Controller), and/or a LSS special function illuminator 252 (a LSS location controller or a LSS emergency vehicle illuminator), each having authority to communicate with the LSS override controller 210 limited to specific situations, times, an/or geographical locations. Their primary functions is providing assistance to specialized personnel to control the AV or provide specialized instructions to assist control functions, both in specific limited situations or locations.

LSS terminal controllers are owned by terminal operators and primarily used for maneuvering an AV in the home or destination terminal when congested conditions make AV autonomous control impractical or impossible. These controllers may have authority limited by time, location and vehicle ID, operating only within a limited distance of home or destination terminals and authorization based on vehicle ownership, vehicle ID provided by the owner/operator, or within a destination terminal included in route map.

LSS maintenance controllers are primarily used for maneuvering an AV by maintenance personnel at a failure location or at a maintenance terminal. These controllers have authority limited by location and vehicle ID, operating only within a limited distance of a specific location and must be specifically authorized by owner/operator, by location and AV ID including license number, DOT number, or VIN. Authority to control the AV is transferred from the AV owner/operator by the transmittal of a signed certificate with a validity period to the maintenance facility.

LSS location controllers are primarily used in locations that require the AV 201 access information not otherwise available. LSS location controllers can provide additional information to an AV override controller 210, including local regulations, transient road conditions, instructions, detailed maps of non-public areas, or other information allowing an AV operate outside of normal parameters, e.g., a parking structure where space and maneuverability are limited, and where GPS is inoperable requiring different operating modes implemented at that location. The LSS location controller may be positioned at the entrance to the parking structure, and transmits a periodic signal providing necessary information to approaching AVs.

In such a case information may include: required operating mode(s), availability of parking and recharge facilities, cost and billing structure, a detailed map with required traffic flow patterns, up-ramp and down-ramp locations, drop off and pickup zone locations, location of free parking spaces, location of an assigned parking location, or other essential data allowing AVs operate. The required operating mode is what specific technology has been implemented inside the structure to assist the AV in locating parking or parking with recharge capability, e.g., buried wire guidance, laser locators, etc.

In an alternate embodiment, a LSS location controller may support a query mode where the LSS override controller can request additional or more specific information.

In another alternate embodiment, a LSS location controller can ensure temporary changes to traffic signage can be dynamically updated and cannot be misinterpreted by the Automated Driving System (ADS) controller, i.e., each sign employing a LSS location controller that periodically transmits a secure message containing critical information, including: it's primary message (stop, slow, go, yield, speed limit, etc.), controlled roadway identifier (e.g., street name, highway number), lane identifier (if applicable) date, time, GPS coordinates, jurisdiction, and health. If the signage is battery powered, the health data can be used by vehicle dispatch to notify the proper jurisdiction of any power issue. In the case of traffic lights, the LSS location controller can be integrated into the traffic light. Most modern red, yellow, green traffic lights employ a circular array of LEDs as their primary light source. These LED can be modulated directly or augmented with signaling LEDs to carry information, I.e., the signal between the LSS location controller and the LSS override controller.

In still another alternate embodiment, a LSS location controller can be located at the entrance to recharging or refueling stations. As the adoption of AV technology accelerates, the layout of these stations will require frequent updates as the facilities increase capacity. The LSS location controller can be programmed to provide the latest layout, capabilities, and capacity including during construction to optimize operation.

In still another alternate embodiment, a LSS location controller can be used when emergency roadway conditions require, periodically transmitting a “RoadClosed” command to oncoming AV traffic that a lane, the partial roadway, or the full roadway has been closed. The command may include additional information to designate the type of closure as well as the GPS coordinates of the closure, and if available, an optional route map that would result in the AV's return to it's designated route. This command employs only RF signaling modes.

The LSS components, i.e., LSS override controller 210 and LSS external controllers 230 are housed in enclosures that provide protection of internal memory, including one or more of: evidence of tampering, physical security mechanisms, or physical security mechanisms providing a complete envelope of protection around the enclosure with the intent of detecting and responding to all unauthorized attempts at physical access.

LSS special function controllers 250 are specialized versions of LSS illuminators and LSS manual controllers that include: LSS terminal controllers, LSS maintenance controllers, LSS location controllers, and LSS emergency vehicle controllers (e.g., fire trucks, ambulances, rescue, and hazardous materials vehicles), each having authority to communicate with the LSS override controller limited to specific specific situations and/or geographical locations. Their primary functions is providing assistance to specialized personnel other than law enforcement personnel to control the AV or provide specialized instructions to assist control functions, both in specific limited situations or locations.

LSS terminal controllers are primarily used for maneuvering an av in the home or destination terminal when congested conditions make av control impractical or impossible. These controllers have authority limited by location and vehicle ID, operating only within a limited distance of home or destination terminals and authorization based on vehicle ownership, vehicle ID provided by the owner/operator, or within a destination terminal included in route map.

LSS maintenance controllers are primarily used for maneuvering an AV by maintenance personnel at a failure location or at a maintenance terminal. These controllers have authority limited by location and vehicle ID, operating only within a limited distance of a specific location and must be specifically authorized by owner/operator, by location and AV ID including license number, DOT number, or VIN.

LSS emergency vehicle controllers are used to request AVs yield right-of-way by periodically transmitting a “Yield” command including their current GPS coordinates and route to all AVs within range.

LSS location controllers are primarily used to provide information to a LSS override controller or to an AV ADS controller including local regulations, instructions, detailed maps of non-public areas, or other information allowing an AV operate outside of normal parameters, e.g., a parking structure where space and maneuverability are limited, and where GPS is inoperable requiring different operating modes implemented at that location. A LSS location controller may be positioned at the entrance to the parking structure, and periodically transmits a signal providing necessary information to approaching AVs. In such a case information may include: required operating mode(s), availability of parking and recharge facilities, cost and billing structure, a detailed map with required traffic flow patterns, up-ramp and down-ramp locations, drop off and pickup zone locations, location of free parking spaces, location of an assigned parking location, or other essential data allowing AVs operate. The required operating mode is what specific technology has been implemented inside the structure to assist the AV in locating parking or parking with recharge capability, e.g., buried wire guidance, laser locators, etc. The information could be provided in an XML format for increased flexibility.

In an alternate embodiment, LSS external controllers employing focused or wide beam RF operational modes may illuminate multiple vehicles and all vehicles will respond to the signal, making communication difficult or logo impossible, therefore, the transmit chain is configured for Carrier Sense Multiple Access/Collision Avoidance (CSMA/CA). Prior to transmission, each LSS external controller attempts to detect the presence of a carrier signal from another controller before attempting to transmit. If a carrier is sensed, the node waits for the transmission in progress to end before initiating its own transmission.

All LSS Components are assigned a MAC address, type, version and serial number during manufacture that are encoded into the hardware and available to software for selection and identification. The type field allows the LSS override controller identify the specific type of LSS external controller connecting. The version number encodes both the hardware and software version. The field definitions are as follows:

TABLE 1
MAC Address field - 6 byte
0x000000000001 - 0xffffffffffff
Type field - 2 byte (hexadecimal)

| Value | Definition |
|---|---|
| 0x0000 | Illegal |
| 0x0101 | LSS override controller |
| 0x0102 - 0xffff | Reserved |
| 0x0001 | LSS Handheld illuminator |
| 0x0002 | LSS Automobile Mounted illuminator |
| 0x0003 | LSS helicopter mounted illuminator. |
| 0x0004 | LSS manual controller |
| 0x0005 | LSS Fence |
| 0x0006 | Terminal controller |
| 0x0007 | Maintenance controller |
| 0x0008 | LSS location controller |
| 0x0009 | LSS emergency vehicle controller |
| 0x000a - 0x00ff | Reserved |

Version field - 4 byte

| Hardware Version/Revision | | Software Version/Revision | |
|---|---|---|---|
| Version | Revision | Version | Revision |
| 0x01 - 0xff | 0x00 - 0xff | 0x01 - 0xff | 0x00 - 0xff |

Serial Number field - 4 byte
0x00000001 - 0xffffffff

LSS software packages comprise: firmware, optional hypervisor, real-time operating system(s), and application code, each with distinct identification. Each software package identification includes: manufacturer, name, version, revision (release number), date, and target processor type.

LSS software source code is developed in a secure development environment, with automated configuration management, life-cycle management, secure delivery procedures, and well developed tools and techniques. The source code is shared across all LSS Components.

LSS software is managed by a package manager, e.g., RPM Package Manager (RPM), and is updated via the Network Interface available in each LSS Component. The version, revision, and date of each software package is verified at boot time for all LSS Components and updated automatically if necessary. Each software package replaced is recorded in an audit record and the audit record transmit to the appropriate audit server. All updates are obtained from authorized white-listed sites requiring mutual authentication as well as a cryptographic hash obtained from a logically distinct site and compared to a calculated hash. All LSS software packages are require a valid digital signature which is checked after validation of the cryptographic hash.

LSS Components employ a secure boot protocol, where the boot is successful only if the OS can verify the integrity of the bootchain up through the OS kernel and all executable application code prior to its execution employing a digital signature using a hardware-protected asymmetric key, and a hardware-protected hash.

The bootchain of the OS is the sequence of software, to include the OS loader, the kernel, system drivers or modules, and system files, which ultimately result in loading the OS. The first part of the OS, usually referred to as the first-stage bootloader, is loaded by the platform firmware after the firmware has verified its integrity.

According to the preferred embodiment, the LSS override controller 210 software, electronic components, and physical housing are logically and physically distinct and independent from the AV ADS controller 221 and is functionally able to assert unconditional control over the AV ADS controller 221, and may bypass the AV ADS controller 221 to assert unconditional control over the vehicle steering, braking, drive and power systems.

In an alternate embodiment, the LSS override controller 210 software and electronic components are logically and physically distinct and independent from the AV ADS controller 221 and is functionally able to assert unconditional control over the AV ADS controller 221, and may bypass the AV ADS controller 221 to assert unconditional control over the vehicle steering, braking, drive and power systems.

In another alternate embodiment, the LSS override controller 210 software is logically distinct from the AV ADS controller 221, i.e., the LSS override controller 210 may be physically integrated into the AV ADS controller 221 where the software executes in a separate protected domain that is logically distinct from the AV ADS controller 221 software. E.g., as a separate application running under an operating system (OS) executing on hardware employing a memory management unit (MMU), or as an application running under a separate OS environment under a hypervisor. A part of, or all of the LSS override controller 210 hardware is shared with the AV ADS controller 221; however, the LSS override controller 210 is functionally able to assert unconditional control over the AV ADS controller 221, and may bypass the AV ADS controller 221 to assert unconditional control over the vehicle steering, braking, drive and power systems.

In still another embodiment, the deterministic LSS override controller 210 is logically and physically indistinct from the AI-based AV ADS controller 221, i.e., the LSS override controller 210 may be fully integrated into the AV ADS controller 221; however, is functionally independent and able to assert unconditional control over the AV ADS controller 221, and may bypass the AV ADS controller 221 to assert unconditional control over the vehicle steering, braking, drive and power systems.

In still another embodiment, the LSS override controller 210 supports an additional interface using the LSS Transducer RF antenna, i.e., a Wi-Fi Direct employing a “soft AP” (software Access Point) that allows an additional external controller (not shown) connect. This interface may only be supported on LSS Transducers in RF Rx/Tx omnidirectional mode (Omnidirectional receive and transmit). The Wi-Fi direct controller may be a bespoke design, or a commercially available mobile smartphone or tablet with application software that emulates a LSS Manual Controller. Additionally, the Wi-Fi direct controller may support LSS override controller administrative functions using appropriate emulation software.

With reference now to FIG. 3, FIG. 4, and FIG. 5, depictions of the typical usage of a LSS Handheld illuminator 300, a LSS Automobile Mounted illuminator 400, and a LSS helicopter mounted illuminator 500 in accordance with a preferred embodiment of the present invention. Those of ordinary skill in the art will appreciate that the LSS Automobile Mounted illuminator and the LSS helicopter mounted illuminator will require external mounts that have manual or automated azimuth and elevation control for pointing. Typically, law enforcement personnel will utilize a LSS illuminator as part of an interdiction process when an AV must be stopped for inspection or where other means have failed or deemed unusable or unsafe. The LSS illuminator is used to signal the AV that authorized personnel are overriding AV ADS control. A LSS illuminator may be a single mode, or multi-mode device; multi-mode may allow different modes to be selectable or all modes may be used simultaneously. Additionally, each illuminator depicted may be integrated into other systems already required; e.g. the LSS handheld illuminator could be integrated into a flashlight, the LSS Automobile Mounted illuminator could be integrated into the automobile's emergency lighting. Those of ordinary skill in the art will appreciate that these modes may vary according to the manufacturer, design requirements, requirements mandated by local and federal regulatory bodies, as well as intended usage and range. Typical modes include: Light Emitting diode (LED), visible laser, infrared laser, acoustic, radio frequency (RF) and/or other applicable technologies; multi-mode devices would utilize two or more of these (or two or more frequencies), either selectably or automatically. The illuminator enclosures 301, 403, and 503 each provides physical protection of the internal electronic components, that physical protection including evidence of tampering, including tamper-evident coatings or seals that must be broken to attain physical access to the memory within the module, or pick-resistant locks on covers or doors to protect against unauthorized physical access.

In an alternate embodiment, the LSS illuminator enclosures 301, 403, and 503 each provides physical security mechanisms that include the use of strong enclosures and tamper-detection/response circuitry that zeroes all plaintext critical security parameters (CSPs) within memory when the removable covers or doors of the enclosure are opened.

In another alternate embodiment, the LSS illuminator enclosures 301, 403, and 503 each provides physical security mechanisms that include a complete envelope of protection around the enclosure with the intent of detecting and responding to all unauthorized attempts at physical access. Penetration of the enclosure from any direction has a very high probability of being detected, resulting in the immediate deletion of all plaintext CSPs within memory.

Those of ordinary skill in the art will understand the LSS Handheld illuminator requires battery power, and that the LSS Automobile Mounted illuminator and LSS helicopter mounted illuminator require power from their respective vehicles. Additionally, both the LSS Automobile Mounted illuminator and LSS helicopter mounted illuminator may be separated into components internal and external to the vehicle.

With reference again to FIG. 3, the depiction of a LSS Handheld illuminator 300 demonstrating typical usage, shows the enclosure 301, User Input mechanisms 303, 305, 307, 309, and 311, and focused optical output beam 313 in accordance with a preferred embodiment of the present invention. Also shown for purposes of demonstrating usage are an autonomous vehicle 315 and AV LSS Transducer 317. The User Input mechanisms 303, 305, 307, 309, and 311 each comprise a push button and debounce electronics (or equivalent functionally) that when actuated (either singly, in concert, or in a defined sequence) send predefined commands to and receive responses from a LSS override controller (not shown) via the focused output/input beam 313 illuminating AV LSS Transducer 317 mounted on autonomous vehicle 315.

In an alternate embodiment the LSS illuminator enclosure 301, provides protection of internal memory, including one or more of evidence of tampering, physical security mechanisms, or physical security mechanisms providing a complete envelope of protection around the enclosure with the intent of detecting and responding to all unauthorized attempts at physical access.

In another alternate embodiment the LSS illuminator enclosure 301 is designed to defeat or mitigate the threat of an electromagnetic pulse (EMP), an intentional electromagnetic interference (IEMI) event, or a geomagnetic disturbance (GD).

With reference again to FIG. 4, the depiction of a LSS Automobile Mounted illuminator 400 demonstrating typical usage, shows the enclosure 403, mounted on law enforcement automobile 401 and focused optical output beam 405 in accordance with a preferred embodiment of the present invention. Also shown for purposes of demonstrating usage are a target autonomous vehicle 407 and LSS Transducer 409. The user Input mechanisms are not shown and may consist of a control unit and display panel mounted remotely in the vehicle and may be integrated into existing systems, e.g. laptop computer. User inputs control the steerable mount in azimuth and elevation so the AV LSS Transducer 409 on the target autonomous vehicle may be properly illuminated. The steerable mount may be manually controlled, or assisted by a automatic targeting mechanism. Once focused on the AV LSS Transducer 409, predefined commands are sent to and responses received from a LSS override controller (not shown) via the focused output/input beam 405 illuminating AV LSS Transducer 409 mounted on autonomous vehicle 407.

In an alternate embodiment the LSS Automobile Mounted illuminator enclosure 403 and the control unit enclosure mounted remotely in the vehicle (not shown) provides protection of internal memory, including one or more of evidence of tampering, physical security mechanisms, or physical security mechanisms providing a complete envelope of protection around the enclosure with the intent of detecting and responding to all unauthorized attempts at physical access.

In an alternate embodiment the LSS Automobile Mounted illuminator also implements an independent mode of operation to be used when emergency roadway conditions require. In this mode, a “RoadClosed” command may be periodically transmit to signal to oncoming AV traffic that a lane, the full roadway, or a partial roadway has been closed. The command may include additional information to designate the type of closure as well as the GPS coordinates of the closure, and if available, an optional route map that would result in the AV's return to it's designated route. This command employs only RF signaling modes.

In still another alternate embodiment the LSS Automobile Mounted illuminator enclosure 403 and the control unit enclosure mounted remotely in the vehicle (not shown) are designed to defeat or mitigate the threat of an electromagnetic pulse (EMP), an intentional electromagnetic interference (IEMI) event, or a geomagnetic disturbance (GD).

With reference again to FIG. 5, the depiction of a LSS helicopter mounted illuminator 500 demonstrating typical usage, shows the enclosure 503, mounted on law enforcement helicopter 501 and focused optical output beam 505 in accordance with a preferred embodiment of the present invention. Also shown for purposes of demonstrating usage are an autonomous vehicle 507 and AV LSS Transducer 509. The user Input mechanisms are not shown and may consist of a control unit and display panel mounted remotely in the helicopter. User inputs control the steerable mount in azimuth and elevation so the AV LSS Transducer 509 on the target autonomous vehicle may be properly illuminated. The steerable mount may be manually controlled, or assisted by a automatic targeting mechanism. Once focused on the AV LSS Transducer 509, user commands are sent to and responses received from a LSS override controller (not shown) via the focused optical output beam 505 illuminating AV LSS Transducer 509 mounted on autonomous vehicle 507.

In an alternate embodiment the LSS helicopter mounted illuminator enclosure 503 and the control unit enclosure mounted remotely in the vehicle (not shown) provide protection of internal memory, including one or more of evidence of tampering, physical security mechanisms, or physical security mechanisms providing a complete envelope of protection around the enclosure with the intent of detecting and responding to all unauthorized attempts at physical access.

In another alternate embodiment the LSS helicopter mounted illuminator enclosure 503 is designed to defeat or mitigate the threat of an electromagnetic pulse (EMP), an intentional electromagnetic interference (IEMI) event, or a geomagnetic disturbance (GD)

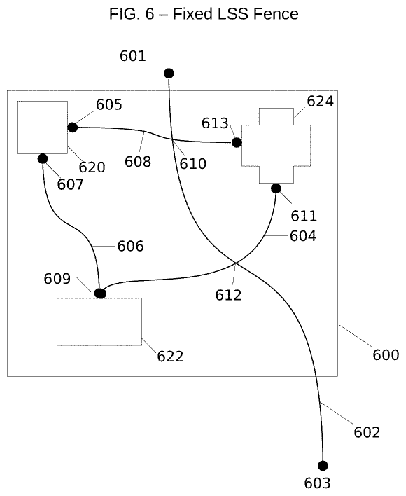

With reference again to FIG. 6, the depiction of a use case for a LSS Fence, shows a geographic area 600 having three restricted areas 620, 622, and 624 where autonomous vehicle traffic is limited or restricted in accordance with a preferred embodiment of the present invention. In this depiction, the main geographic area 600 is accessed by roadway 602 and the three restricted areas 620, 622, and 624, are connected by roadways 604, 606, and 608 at intersections 610 and 612. LSS Fences are located at the entry points to each of the restricted areas at 605, 607, 609, 611, and 613 and periodically transmit a “Fence” command comprising the GPS coordinates of the restricted area. As the autonomous vehicle approaches a restricted area marked with the LSS fence, the LSS override controller receives the “Fence” command and, notifies the AV ADS controller to avoid the restricted area, whereby the AV ADS controller requests an alternate route map to complete the trip. In the case the LSS override controller detects actual AV intrusion into a LSS electronic fenced area, the vehicle is reliably stopped by bypassing the AV ADS Controller, operating directly on the motor feed, steering, and braking mechanisms. The “Fence” command is programmable via a secure remote administrative interface by the owning jurisdiction and includes the GPS coordinates of the restricted area and a set of restriction or allowance criteria specifying parameters associated with the restricted area, e.g., time and date, vehicle class, vehicle height, width, length, and current gross vehicle weight (GVW).

In an alternate embodiment, the LSS Fences are located at the entry points to the geographic area 600 at 601, and 603, again periodically transmitting a “Fence” command comprising the GPS coordinates, the restriction and the allowance criteria of each of the three restricted areas 620, 622, and 624 within the geographic area 600. In this manner, the number of LSS Fences is reduced.

In another alternate embodiment the LSS Fence enclosure (not shown) provide protection of internal memory, including one or more of evidence of tampering, physical security mechanisms, or physical security mechanisms providing a complete envelope of protection around the enclosure with the intent of detecting and responding to all unauthorized attempts at physical access.

In still another alternate embodiment the LSS Fence enclosure (not shown) is designed to defeat or mitigate the threat of an electromagnetic pulse (EMP), an intentional electromagnetic interference (IEMI) event, or a geomagnetic disturbance (GD)

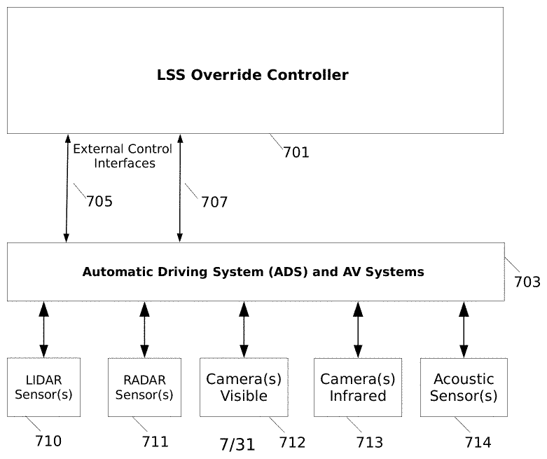

With reference now to FIG. 7, a block diagram of a LSS override controller 701, AV ADS controller and AV Systems 703, and remote sensors: LIDAR Sensor(s) 710, Radar Sensor(s) 711, Visible Camera(s) 712, Infrared Camera(s) 713, and acoustic Sensor(s) 714 in accordance with a preferred embodiment of the present invention. Those of ordinary skill in the art will understand the remote sensors are design dependent and the sensors depicted are intended as an example only. The LSS override controller 701 is purposefully shown above the AV ADS controller and AV System 703, showing the relationship and ADS Control Interfaces 705 and 707, because it can unconditionally override the AV ADS controller and, if necessary bypass the AV ADS controller and interface directly with the AV System.

In an alternate embodiment the LSS override controller 701, ADS and AV system 703, External Control Interfaces 705 and 707, LIDAR Sensor(s) 710, Radar Sensor(s) 711, Visible Camera(s) 712, Infrared Camera(s) 713, and acoustic Sensor(s) 714 are housed in enclosures that defeat or mitigate the threat of an electromagnetic pulse (EMP), an intentional electromagnetic interference (IEMI) event, or a geomagnetic disturbance (GD). In cases where the LSS override controller 701 and ADS and AV System 703, including remote sensors: LIDAR Sensor(s) 710, Radar Sensor(s) 711, Visible Camera(s) 712, Infrared Camera(s) 713, and oustic Sensor(s) 714 are housed in separate enclosures, all signal connections between them, e.g., External Control Interfaces 705 and 707, employ signaling means having minimum susceptibility to these threats, e.g., fiber optic signals. Remote sensors may require conditioning electronics that convert incoming and outgoing signals to fiber optic signals. Additionally, all motors employ shielded enclosures and cables to reduce susceptibility. Design goals emphasize rapid replacement of components that cannot be protected. Guidelines taken from MIL-STD-188-125-2 Part 2, for transportable systems should be followed.

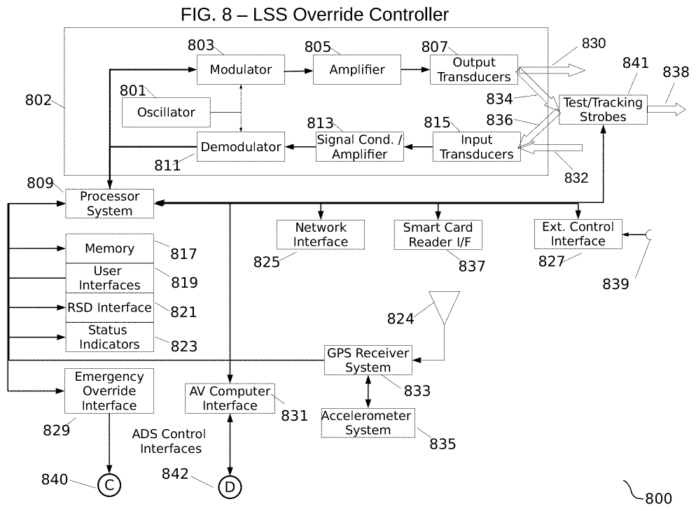

The LSS override controller controller 701 is further explained in the description of FIG. 8—LSS override controller. The ADS and AV System 703 and the external control interfaces 705 and 707 are further explained in the description of FIG. 11—AV ADS controller and AV Systems.

With reference now to FIG. 8, a diagram illustrating electronic components of a LSS override controller controller 800 used for vehicle management and to mitigate and/or prevent autonomous vehicle misuse is depicted in accordance with a preferred embodiment of the present invention. The LSS override controller described herein, acting as a listener, communicates directly with the LSS external controllers acting as initiators as described in discussions of FIG. 2.

In this illustrative example, the components organized into the following subsystems: processing, transmit/receive chain, user interface and Network Interface; the subsystems may be appropriately separated into physically different enclosures, e.g., the transmit and receive chains located in one package mounted on top of the AV and the remainder in a more accessible location. Additionally, the components may be integrated into the AV ADS controller or into existing AV sensors such as LIDAR, radar, GNSS, or acoustic, etc; furthermore, significant anti-tampering characteristics of the LSS override controller may be gained through the use of integrated sensors. e.g., if an integrated LSS/LIDAR sensor were tampered, the LIDAR system would also be downgraded and the system fail. Additionally, some components, such as input transducers and/or output transducers, may be integrated into the vehicle's running, braking, or emergency lighting. Those of ordinary skill in the art will appreciate that the hardware depicted in FIG. 8 may vary, e.g., other components may be used in the transmit and/or receive chain, or other subsystems.

The transmit/receive chain 802 includes Oscillator 801 which generates the carrier frequency for RF transducers and the signaling frequency of optical and acoustic transducers, the Modulator 803 which modulates the oscillator signal with the data from the Processor System 809, Amplifier 805 which amplifies the signal, the LSS Output Transducers 807 comprises one or more of an optical, acoustic, or RF emitter which emits the modulated signal 830 intended for the communicating LSS external controller.

The transmit/receive chain 802 also includes the LSS Input Transducers 815 which comprises one or more of an optical, acoustic, or RF detector which receives the modulated signal 832 from a LSS external controller, Signal Conditioner and Amplifier 813 which synchronizes to the incoming signal and amplifies to the proper level, and Demodulator 811 which recovers the information content from the modulated signal and sends to the Processor System 809.

The transmit signal 830 and the received signal 832, are converted to/from electrical signals using the AV LSS Transducers 815 and 807 mounted on the AV. These transducers may be one or more of acoustic, optical, or radio frequency (RF). Acoustic energy may be transduced by a piezoelectric device, a magnetostrictive device or other acoustic transducer. RF energy may be transduced by one or more of: a Yagi-Uda antenna, a monopole or a dipole antenna, a parabolic, or other suitable RF antenna. Optical energy may be emit by Light Emitting diode (LED), visible laser, infrared laser or other optical emitter and sensed by a photo diode. In some embodiments, the optical frequency of the optical transducers may fall within an atmospheric absorption frequency band such as between 1.3 microns to 1.4 microns or between 1.8 micron and 1.95 microns reducing potential susceptibility to sunlight saturation.

Both the data sent from the Processing Chain 809 to the Modulator 803 and the data received from the Demodulator 811 sent to the Processing Chain 809 (application data) employ the TLS protocol in the application layer using FIPS approved algorithms to provide secure connectivity, i.e., message confidentiality, message integrity, mutual identification and authentication, reliability, forward secrecy and non-repudiation. Identification and authentication may employ Public Key Infrastructure (PKI) X.509 certificates issued by a Certificate Authority (CA).

The processing chain is comprised of Processor System 809, Memory 817, and a Real Time Clock (RTC) (not shown). The Processor System 809 may comprise a single chip with a single or multiple processors or multiple chips each with a single or multiple processors; where each processor comprises at least one distinct, logical processing element, the at least one element employing a real-time, deterministic operating system. The real-time operating system performs time critical operations, other processing elements performing non-time critical operations.

The Processor System 809 interfaces to the Modulator 803, Demodulator 811, Memory 817, User Interfaces 819, RSD Interface 821, Status Indicators 823, Network Interface 825, External Control Interface 827, Emergency Override Interface 829, AV ADS controller Interfaces 831, GPS Receiver System 833, Smart Card Reader Interface 837, the Test/Tracking Strobe 841, and RTC (not shown).

The Processor System 809 performs all processing tasks including time keeping using the RTC updated by Network Time Protocol (NTP) at startup and periodically thereafter, generating transmit signals, interpreting receive signals, user input/output functions, activation and control of the Test/Tracking Strobe 841, and driving the AV ADS controller Interfaces 831 and Emergency Override Interface 829.

The test/tracking strobes 841 photodiodes/photoemitters are enabled only during self-test and strobe tracking modes and provide a variable amplitude output signal 836 during test of the optical Input Transducer 815 and monitor the output beam 834 of the optical Output Transducer 807. During strobe tracking mode, the strobe photoemitters transmit a beam 838 of 1s and 0s well below the signaling frequency of the LSS Transducer so the tracking signal can be effective but not interfere with signaling.

Memory 817 comprises RAM, ROM, and NVRAM, storing information including: program code, operational data, audit data, and critical security parameters. The RSD (removable storage device) interface 821 provides a means to add to, update or download information stored in memory 817. The RSD Interface may be configured for USB (Universe Serial Bus), SD (Secure Digital) card or other types as the design demands. Status Indicators 823 may be configured to indicate system health status, transmit/receive status, or other information as the design dictates. The Network Interface 825 employs the TLS protocol using FIPS approved algorithms to provide secure Internet connectivity, i.e., message confidentiality, message integrity, mutual identification and authentication, reliability, forward secrecy, and non-repudiation.

The Network Interface 825 allows remote program code updates, certificate management including Certificate Revocation List (CRL) or Online Certificate Status Protocol (OCSP) certificate revocation, remote audit server access, Network Time Protocol (NTP), and other required functions; all Internet access may be required to have white-listed addresses.

Remote audit server access ensures all LSS override controller 800 audit records are maintained externally to protect the audit trail; the listener may be located at vehicle dispatch owned and maintained by the AV owner/operator, it may be owned and maintained by a commercial service, or other arrangement; however, it must provide secure storage and access to the audit trail. The connection to the audit server must guarantee the audit records are received securely and without error. The Network Interface 825 may be configured to support mobile device data (4G, 5G), mobile radio, satellite, or other means as design dictates.

The External Control Interface 827 provides direct wired connectivity to a LSS manual controller that sends commands to the LSS override controller to assert control over the AV directly, overriding all functionality of the native AV ADS controller. The LSS manual controller connects using connector 839 which is located remotely on the exterior of the AV and when connected and connection established, AV LSS Transducers 815 and 807 are disabled until the LSS manual controller disconnected. The External Control Interface 827 employs the TLS protocol using FIPS approved algorithms to provide secure connectivity, i.e., message confidentiality, message integrity, mutual identification and authentication, reliability, forward secrecy and non-repudiation.

The AV Computer Interface 831 interfaces to the AV ADS controller to send commands or instructions to the AV ADS Controller, receive responses to the commands or instructions from the AV ADS Controller, receive heartbeat or other health information from the AV ADS Controller, and other necessary functions. The AV Computer Interface 831 interface is customizable, allowing the LSS System interface to different manufacturer's AV ADS Controller. The interface may be implemented entirely by hardware, or by hardware and software controlled by an independent microprocessor.

An Emergency Override Interface 829 is implemented to bypasses the AV ADS controller and operate directly on the motor feed, braking, steering and power controllers for emergency situations that require immediate halt of the AV, e.g., failure of the AV ADS controller to respond to commands via the AV Computer Interface 831, failure or compromise of the AV ADS controller software, failure of the AV ADS controller hardware, or failure of a critical control sensor. The Emergency Override Interface 829 is customizable, allowing the LSS System interface to different manufacturer's motor feed, braking, steering and power controllers. The interface may be implemented entirely by hardware, or by hardware and software controlled by an independent microprocessor. Off page connectors “C” 840 and “D” connect to the ADS Control Interfaces “C” 1120 and “D” 1122, respectively, shown on FIG. 11. The User Interfaces 819 may be configured as a remote interface supporting SSH, HTTPS, or other secure communication technology for administrative purposes; the interface is logically and physically distinct from the Network Interface 825.

In an alternate embodiment the User Interfaces 819 may be configured to support a personal identification number (PIN) entry pad as well as the remote interface supporting SSH, HTTPS, or other secure communication technology.

The PIN entry pad supports multi-factor authentication of the entity accessing the LSS override controller for administrative purposes in conjunction with the Smart Card Reader Interface 837. The smart card reader may be provided for U.S. DOD usage, U.S. Federal usage, or other high security environments where a Personal Identification Verification (PIV) card, a PIV-Interoperable (PIV-I) card, a Common Access Card (CAC), or other smart card must be used to provide the multi-factor authentication necessary to administer the LSS override controller in that environment.

A CAC is a smart card about the size of a credit car, once inserted into the reader, the device asks the user for a PIN, and once entered, the PIN is matched with the stored PIN on the CAC. If successful, the Electronic Data Interchange Personal Identifier (EDIPI) number is read off the ID certificate on 154o the card, and then sent to a Processor System where the EDIPI number is matched with an access control system, such as Active Directory or LDAP. After three incorrect PIN attempts, the chip on the CAC will lock. where in combination with a PIN, a CAC satisfies the requirement for two-factor authentication. The CAC also satisfies the requirements for digital signature and data encryption technologies: authentication, integrity and non-repudiation.

A high-accuracy GPS Receiver 833, GPS Antenna 824 and the Accelerometer System 835 provide accurate LSS location data that is independent of the AV ADS Controller. The Accelerometer System 835 provides short term AV acceleration, velocity, and position data in cases where GPS signals are temporarily unavailable e.g., under raised highway structures or in a dense city environment where high rise buildings obstruct GPS signals. LSS location data may also be sent to the AV ADS control system via the ADS command interface to increase system reliability.

LSS location data is used in conjunction with “Fence” commands received from LSS Fence installations. As the vehicle approaches a restricted area marked with the LSS fence, the LSS override controller receives the “Fence” command containing the GPS coordinates of the restricted area, and notifies the AV ADS controller to avoid the restricted area, passing the GPS coordinates to the AV ADS Controller. The AV ADS controller should then request an alternate route map to complete the trip specifying the restricted coordinates. In the case the LSS override controller detects actual AV intrusion into a LSS fenced area, the AV is halted via the Emergency Override Interface 829 and notifies the vehicle dispatch of the failure. Once the AV has been stopped using the Emergency Override Interface 829 after a “Fence” command was received (and ignored), it can be restarted only by authorized law enforcement or authorized maintenance personnel.

To increase reliability, at startup the LSS override controller performs a self test of each LSS component and AV LSS Transducers 815 and 807. This check includes validation of all certificates including a CRL or OCSP check of certificate revocations status and ensuring the enclosure physical security mechanisms are functional. Additionally, the current CRL is downloaded from the appropriate CA. A failure of any component results in the vehicle being removed from service until resolved. Upon completions, the self-test results are transmit to the vehicle dispatch.

To reduce misuse caused by failure of the AV ADS controller, the LSS override controller is logically distinct and independent from the AV ADS controller and may assert unconditional control over the AV ADS controller via the AV Computer interface 831, and may bypass the AV ADS controller to assert unconditional control over the vehicle steering, braking, drive and power systems via the Emergency Override Interface. To detect an AV ADS controller failure, the LSS override controller can request a periodic heartbeat be sent from the AV ADS controller via the AV Computer Interface 831. If the heartbeat stops for more than a preset period, the LSS override controller will assume the AV ADS controller has failed, halt the AV via the Emergency Override Interface 829 and notify the vehicle dispatch of the failure.

As some AV ADS controller failure modes may result in deviations from the route prescribed in the route map, the LSS override controller can request the current route map from the AV ADS controller via the AV Computer Interface 831 or directly from Vehicle dispatch, where the route can be continuously checked by the LSS override controller 800. Using the GPS Receiver 833, the LSS override controller 800 can monitor AV position, and for small route deviations can transmit corrections to the AV ADS Controller, whereas large route deviations result in halting the vehicle via the Emergency Override Interface 829 and notifying the vehicle's dispatch of the action taken and location of the AV. The LSS override controller is configured for route map in a standard format, such as GPX (GPS eXchange) format, or equivalent. Additionally, all route maps must possess a valid digital signature. The Accelerometer System 835, acting in conjunction with the GPS Receiver 833 can monitor AV velocity and acceleration and, if either exceeds a preset level, the LSS override controller may notify the AV ADS via the control interface. If necessary, the LSS override controller may assert control of the AV via the Emergency Override Interface 829 and notify the vehicle's dispatch of the action taken and location of the AV.

In an alternate embodiment, the LSS override controller may prevent catastrophic failures if the AV ADS controller fails to interpret traffic signage correctly. By monitoring the route map, the LSS override controller can calculate the required deceleration rates as a stop sign is approached. If the AV ADS controller has misinterpreted the sign, the deceleration rate will fail to match the expected rate, wherein the LSS override control will intervene.

In another alternate embodiment, if the AV ADS controller attempts to stop when the route map gives no indication, the LSS override controller can notify vehicle dispatch that a route deviation has occurred, supplying the date, time, and GPS coordinates.

In accordance with a preferred embodiment of the present invention the LSS override controller provides physical protection of the internal electronic components, that physical protection including evidence of tampering, including tamper-evident coatings or seals that must be broken to attain physical access to the memory within the module, or pick-resistant locks on covers or doors to protect against unauthorized physical access.

In an alternate embodiment the LSS override controller provides physical security mechanisms that include the use of strong enclosures and tamper-detection/response circuitry that zeroes all plaintext critical security parameters (CSPs) within memory when the removable covers/doors of the enclosure are opened.

In another alternate embodiment the LSS override controller provides physical security mechanisms that include providing a complete envelope of protection around the enclosure with the intent of detecting and responding to all unauthorized attempts at physical access. Penetration of the enclosure from any direction has a very high probability of being detected, resulting in the immediate deletion of all plaintext CSPs.

In the preferred embodiment, the LSS override controller is logically and physically distinct and independent from the AV ADS controller and may assert unconditional control over the AV ADS Controller, and may bypass the AV ADS controller to assert unconditional control over the vehicle steering, braking, drive and power systems.

In an alternate embodiment, the LSS override controller is logically distinct from the AV ADS controller. In this embodiment, the LSS override controller could execute on the same computer as the ADS, although in a different logical environment, e.g., executing in a virtual environment in a independent operating system environments, with shared or dedicated hardware. Also, in this embodiment, the LSS override controller could execute under the same operating system but in a separate logical domain with shared or dedicated hardware.

With reference now to FIG. 9, a diagram illustrating two views of an integrated directional optical and RF LSS Transducer 900 and 910, in accordance with a preferred embodiment of the present invention. View 900 is a cutaway side view and view 910 is a top view of the AV LSS Transducer which is mounted on the AV in a position that it can be easily illuminated. In some cases, it may be necessary to have multiple AV LSS Transducers mounted in different locations on the AV. In this illustrative example, sixteen (16) sections are illustrated, however, those of ordinary skill in the art will appreciate that the number of sections may be different according design requirements and cost constraints.

With reference first to side view 900, the AV LSS Transducer depicted includes a protective transparent dome 901, sixteen (16) vanes, with only two visible in this view (902 and 906), sixteen (16) signaling photodiodes/photoemitters, with only two visible in this view (903 and 905), RF omnidirectional antenna 904, sun shield 907, sixteen (16) test/tracking strobe photodiodes/photoemitters with only two visible in this view (908 and 909).

With reference now to top view 910, the AV LSS Transducer depicted includes a protective transparent dome 901, sixteen (16) vanes, with only two numbered in this view (902 and 906), RF omnidirectional antenna 904, sixteen (16) signaling photodiodes/photoemitters, also with only two numbered (903 and 905), sun shield 907 and sixteen (16) test/tracking strobe photodiodes/photoemitters with only two numbered in this view (908 and 909).

The vanes and sun shield depicted are made of RF transparent, optically opaque material. Together these limit sunlight entering the signaling photodiodes to reduce sunlight saturation effects to the fewest number of photodiodes possible. Although sixteen (16) vanes, signaling photodiodes/photoemitters, and test/tracking strobe photoemitters are shown in this example, the number could be increased or decreased with a corresponding decrease or increase in the angular impact of the sunlight.

The outputs from each of the sixteen (16) signaling photodiodes in this example are conditioned individually at the signaling frequency prior to combination so that signaling photodiodes saturated by sunlight do not hinder the sensor operations. When law enforcement personnel use a LSS illuminator in optical mode, they must not use in the same direction as incident sunlight. The signaling frequency is the rate at which information is modulated on the optical carrier signal.

In an alternate embodiment, the photodiodes potentially susceptible to sunlight saturation may have the circuit gain reduced automatically to reduce sunlight effects. The automatic circuitry would monitor the vehicle compass orientation, then calculate sun position by time. date, latitude and longitude, then, taking into account the sun shade and vane positions, lower the gain of the appropriate photodiode circuits.

With reference now to FIG. 10, a diagram illustrating two views of an integrated omnidirectional optical and RF LSS Transducer 1000 and 1010, in accordance with an alternate embodiment of the present invention. View 1000 is a cutaway side view and view 1010 is a top view of the AV LSS Transducer which is mounted on the AV in a position that it can be easily illuminated. In some cases, it may be necessary to have multiple AV LSS Transducers mounted in different locations on the AV.

With reference first to side view 1000, the AV LSS Transducer depicted includes a protective transparent dome 1001, RF omnidirectional antenna 1004, and signaling photodiode/photoemitter 1005. With reference now to top view 1010, the AV LSS Transducer depicted includes a protective transparent dome 1001, a single signaling photodiode/photoemitter 1005. The RF antenna is not visible in this view. The single signaling photodiode/photoemitter may be comprised of multiple devices integrated together and may also include a separate photoemitter acting as a tracking beacon.

With reference now to FIG. 11 a block diagram depicting a typical Autonomous Vehicle (AV) automatic driving system (ADS) Controller and AV Systems which the present invention may be implemented. Those of ordinary skill in the art will appreciate that the AV ADS controller is an AI-based control system and both it and the AV systems will vary according to the manufacturer, design requirements, requirements mandated by local and federal regulatory bodies, as well as intended usage. Depicted in FIG. 11 is the AV ADS controller subsystem 1101, the User Input Interfaces 1103, Brake Controller & Brake System 1105, Radio Controller & Radio System 1107, Steering Controller & Steering System 1109, Control Sensor Controllers 1111, Drive Motor Controller & Drive Motor System 1113, GPS Controller & GPS System 1115, Lighting Controller & Lighting System 1117, Other Systems Controller & Systems 1119, and Power Controller 1121. The ADS Control Interfaces 1120 and 1122 provide both ADS command interface 1122 and emergency control interfaces 1120. The ADS command interface 1122 interfaces directly with the AV ADS controller Subsystem 1101 providing access to a command interface that allows an external controller override the normal autonomous operations. The emergency control interface 1120 bypasses the AV ADS controller Subsystem 1101 and interfaces directly to the Brake Controller & Brake System 1105, Steering Controller & Steering System 1109, Drive Motor Controller & Drive Motor System 1113, and Power Controller 1121. Off page connectors “C” 1120 and “D” 1122 connect to the LSS override controller's ADS Control Interfaces “C” 840 and “D” 842 shown in FIG. 8.

The AV ADS controller subsystem 1101 provides all hardware computational resources and software to autonomously control the AV, including the LSS command interface from/to the LSS override controller and artificial intelligence (AI) algorithms; however only the LSS command interface is a subject of this invention. The LSS command interface supports low level commands from and responses to the LSS override controller, the commands separated into informational and maneuver commands as well as required and option commands. Maneuver commands are prioritized over all other tasks. Informational commands return status or other information the AV ADS controller maintains. The minimum set of maneuver commands include: “slow”, “stop”, “forward”, “reverse”, “turn_right”, “turn_left”, and “reroute”. The minimum set of informational commands include: “acknowledge”, “status”, “test”, “start_heartbeat”, “stop_heartbeat”, and “return_current_routemap”.

The “slow” command requires the AV reduce speed at a specified rate.

The “stop” command requires the AV reduce speed and stop.

The “forward” command is a proportional command that specifies the speed the AV moves in the forward direction.

The “reverse” command is a proportional command that specifies the speed the AV is required to move in reverse direction.

The “turn_right” command is a proportional command that specifies the rate of turn to the right.

The “turn_left” command is a proportional command that specifies the rate of turn to the left.

The “reroute” command specifies the geographical coordinates of a restricted area and requires the AV ADS controller request a new route around the restriction, the AV ADS controller returns the new route map to the LSS override controller upon receipt. The route map must possess a valid digital signature.

The “start_heartbeat” command requires the ADS send periodic notifications indicating the ADS health to the LSS override controller. A command parameter specifies the required rate.

The “stop_heartbeat” command stops the ADS from sending heartbeat notifications.

The “acknowledge” command requires the ADS return a simple acknowledgment indicating it is operational.

The “status” command requires the ADS perform some form of self-test and return the results.

The “test” command requires the ADS perform a full self-test on the ADS, subsystems and sensors, and return the self-test reports.

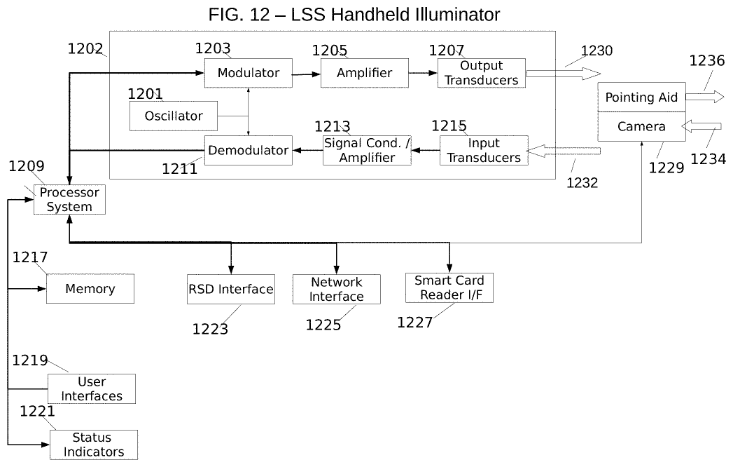

With reference now to FIG. 12, a block diagram illustrating electronic components of a LSS handheld illuminator used by authorized personnel to mitigate and/or prevent autonomous vehicle misuse is depicted in accordance with a preferred embodiment of the present invention. The LSS Handheld illuminator described herein communicates directly with the LSS override controller via the AV LSS Transducer. In this illustrative example, the components organized into the following subsystems: processing, transmit/receive chain, user interface and network interface. Those of ordinary skill in the art will appreciate that the hardware depicted in FIG. 12 may vary; e.g., other components may be used in the transmit and/or receive chain, or other subsystems.

The Processor System 1209 interfaces to Memory 1217 comprising RAM, ROM, and NVRAM, the User Interfaces 1219, the Status Indicators 1221, the RSD (Removable Storage Device) Interface 1223, the Network Interface 1225, Smart Card Reader 1227, a RTC (not shown), and the Camera and Pointing Aid 1229.

The Network Interface 1225 allows remote program code updates, certificate management including CRL or OCSP certificate revocation, remote audit server access, Network Time Protocol (NTP), and other required functions, additionally, all Internet access must have white-listed addresses.

The Processor System 1209 may comprise a single chip with a single or multiple processors or multiple chips each with a single or multiple processors; where each processor comprises at least one distinct, logical processing element, the at least one element employing a real-time, deterministic operating system. The real-time operating system performs time critical operations, other processing elements performing non-time critical operations.

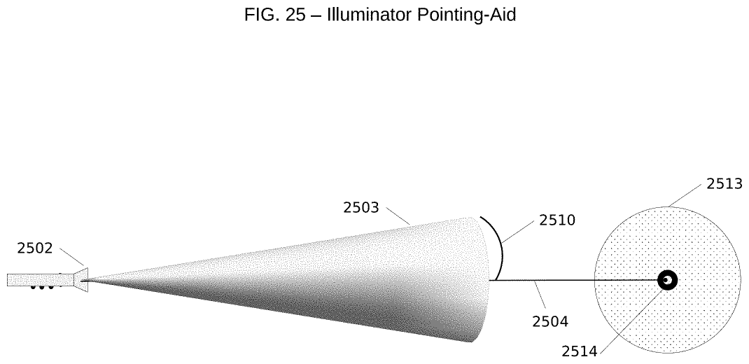

The Processor System 1209 performs all processing tasks including time keeping using the RTC updated by NTP at startup and periodically thereafter, generating transmit signals, interpreting receive signals, user input/output functions, reading and verifying smart card, interfaces to law enforcement dispatch via Network Interface 1225, and control of the Camera and Pointing Aid 1229. The Camera and Pointing Aid 1229 is physically aligned on the axis of the LSS illuminator and records still photos and video in the field of view 1234 as instructed by the user. The pointing aid emits beam 1236 as shown in detail in FIG. 25.

The transmit/receive chain 1202 includes the transmit chain comprised of Oscillator 1201 which generates the carrier frequency for RF transducers and the signaling frequency for optical and acoustic transducers, the Modulator 1203 which modulates the carrier, Amplifier 1205 which amplifies the signal, the output transducers 1207 comprise one or more of an optical, acoustic, or RF emitter which emits the modulated beam 1230 to illuminate the AV LSS Transducer. The transmit/receive chain 1202 also includes the receive chain comprised of the input transducer 1215 which comprises one or more of an optical, acoustic, or RF sensors which receives the modulated beam 1232, Signal Conditioner and Amplifier 1213 which synchronizes to the incoming signal and amplifies to the proper level, and Demodulator 1211 which recovers the information content from the modulated signal and sends for processing.

The transmit signal 1230 and the received signal 1232, are converted to/from electrical signals using transducers 1207 and 1215 mounted on the illuminator. These transducers may be one or more of acoustic, optical, or radio frequency (RF). Acoustic energy may be transduced by a piezoelectric device, a magnetostrictive device or other acoustic transducer. RF energy may be transduced by one or more of: a Yagi-Uda antenna, a monopole or a dipole antenna, a parabolic, or other suitable RF antenna. Optical energy may be emit by Light Emitting diode (LED), visible laser, infrared laser or other optical emitter and sensed by a photo diode. In some embodiments, the optical frequency of the optical transducers may fall within an atmospheric absorption frequency band such as between 1.3 microns to 1.4 microns or between 1.8 micron and 1.95 microns reducing potential susceptibility to sunlight saturation.

The processing chain is comprised of Processor 1209, Memory 1217 and RTC (not shown). The Processor 1209 performs all processing tasks including time keeping using the RTC updated by NTP at startup and periodically thereafter, generating transmit signals, interpreting receive signals, user input/output functions, and interfacing to dispatch; it interfaces to Memory 1217 where program and data are stored, Removable Storage Device Interface 1223 which provides means to load necessary system data, reads and writes user 1/O via User Interfaces 1219, drives Status Indicators 1221, and drives the Network Interface 1225 which ensures all device (LSS illuminator) usage is externally monitored to preserve usage records. The User Interfaces 1219 may be configured as a remote interface supporting SSH, HTTPS, or other secure communication technology for administrative purposes, where the interface is logically and physically distinct from the Network Interface 1225.

To increase reliability, at startup the LSS illuminator performs a self test of each component and sensor. This check includes validation of all certificates including a CRL or OCSP check of certificate revocations status and ensuring the enclosure physical security mechanisms are functional. Additionally, the current CRL is downloaded from the appropriate CA. A failure of any component results in the vehicle being removed from service until resolved. Upon completions, the self-test results are transmit to This check includes validation of all certificates including a CRL or OCSP check of certificate revocations status and ensuring the enclosure physical security mechanisms are functional. Additionally, the current CRL is downloaded from the appropriate CA. A failure of any component results in the vehicle being removed from service until resolved. Upon completions, the self-test results are transmit to the law enforcement dispatch.

In an alternate embodiment the User Interfaces 1219 may be configured to support a personal identification number (PIN) entry pad to support multi-factor authentication of the entity using the LSS handheld illuminator in conjunction with the Smart Card Reader Interface 1227. The smart card reader may be provided for U.S. DOD usage, U.S. Federal usage, or other high security environments where a Personal Identification Verification (PIV) card, a PIV-Interoperable (PIV-I) card, a Common Access Card (CAC), or other smart card must be used to provide the multi-factor authentication necessary to use the LSS handheld illuminator in that environment.

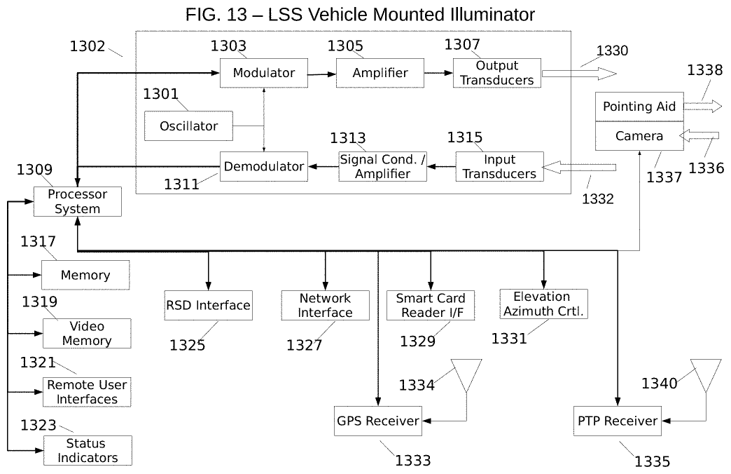

With reference now to FIG. 13, a block diagram illustrating electronic components of a LSS vehicle mounted illuminator used by authorized personnel to mitigate and/or prevent autonomous vehicle misuse is depicted in accordance with a preferred embodiment of the present invention. The LSS vehicle mounted illuminator includes LSS Automobile Mounted illuminator (i.e., mounted on any land vehicle) or LSS helicopter mounted illuminator (i.e., mounted on any airborne vehicle) and communicates directly with the LSS override controller via the AV LSS Transducer. In this illustrative example, the components organized into the following subsystems: processor system, transmit/receive chain, user interface and network interface. Those of ordinary skill in the art will appreciate that the hardware depicted in FIG. 13 may vary; e.g., other components may be used in the transmit/receive chain, or other subsystems.

The Processor System 1309 interfaces to Memory 1317 comprising RAM, ROM, and NVRAM, Video Memory 1319, the Remote User Interfaces 1321, the Status Indicators 1323, the RSD (Removable Storage Device) Interface 1325, the Network Interface 1327, GPS Receiver 1333, Smart Card Reader 1329, the elevation and Azimuth Control 1331, a RTC (not shown), and the Camera and Pointing Aid 1337.

The Network Interface 1327 allows remote program code updates, certificate management including CRL or OCSP certificate revocation, remote audit server access, Network Time Protocol (NTP), and other required functions where all Internet access must have white-listed addresses.

The Processor System 1309 may comprise a single chip with a single or multiple processors or multiple chips each with a single or multiple processors; where each processor comprises at least one distinct, logical processing element, the at least one element employing a real-time, deterministic operating system. The real-time operating system performs time critical operations, other processing elements performing non-time critical operations.

The Processor System 1309 performs all processing tasks including time keeping using the RTC updated by NTP at startup and periodically thereafter, generating transmit signals, interpreting receive signals, user input/output functions, mapping MPPPoXD location inputs, performing edge detection on the camera 1337 field of view to establish vehicle positions, reading and verifying smart card, control of azimuth and elevation, and interfaces to law enforcement dispatch.

The transmit/receive chain 1302 includes Oscillator 1301 which generates the carrier frequency, the Modulator 1303 which generates the carrier frequency for RF transducers and the signaling frequency of optical and acoustic transducers, Amplifier 1305 which amplifies the signal, the output transducers 1307 comprise one or more of an optical, acoustic, or RF emitter which emits the modulated beam 1330 intended for the AV LSS Transducer. The transmit/receive chain 1302 also includes the input transducer 1315 which comprises one or more of an optical, acoustic, or RF sensors which receives the modulated beam 1332, Signal Conditioner and Amplifier 1313 which synchronizes to the incoming signal and amplifies to the proper level, and Demodulator 1311 which recovers the information content from the modulated signal and sends for processing.

The transmit signal 1330 and the received signal 1332, are converted to/from electrical signals using transducers 1307 and 1315 mounted on the illuminator. These transducers may may be one of acoustic, optical, or radio frequency (RF) energy. Acoustic energy may be transduced by a piezoelectric device, a magnetostrictive device or other acoustic transducer. RF energy may be transduced by one or more of: a Yagi-Uda antenna, a monopole or a dipole antenna, a parabolic, or other suitable RF antenna. Optical energy may be emit by Light Emitting diode (LED), visible laser, infrared laser or other optical emitter and sensed by a photo diode. In some embodiments, the optical frequency of the optical transducers may fall within an atmospheric absorption frequency band such as between 1.3 microns to 1.4 microns or between 1.8 micron and 1.95 microns reducing potential susceptibility to sunlight saturation.

The Remote User Interfaces 1321 may be configured as a remote interface supporting SSH, HTTPS, or other secure communication technology for administrative purposes, where the interface is logically and physically distinct from the Network Interface 1327.

The Camera and Pointing Aid 1337 is physically aligned on the axis of the LSS illuminator and can pan and zoom as required using the elevation and Azimuth Control 1331. The camera records still photos and video as instructed by the user in the field of view 1336. The pointing aid emits beam 1338 as shown in detail in FIG. 25.

The high-accuracy GPS Receiver 1333 and GPS Antenna 1334 provide independent location data to establish the position of the law enforcement vehicle.

The LSS Vehicle illuminator has multiple signaling modes available to select a target vehicle: focused optical beam, focused RF beam, wide RF beam, omnidirectional RF, and acoustic beam, all using a modified Point-to-Point Protocol over Xmedia (MPPPoX). MPPPoX can also implement MPPPoX active discovery (MPPPoXD) to obtain the MAC addresses of multiple vehicles in a specified area.

In focused optical beam mode, the beam width is very small and allows focusing and selecting of an individual target vehicle. In focused RF beam mode, the beam width is wider than the optical beam mode, but in sparse traffic conditions, allows focusing and selection of an individual target vehicle. In wide RF beam mode, the beam width is much wider than the focused RF beam, and in traffic conditions where only a single vehicle is within range, allows focusing and selection of that target vehicle; however, it is more likely to select multiple vehicles. In acoustic beam mode, the beam is very restricted in range and is appropriate for selecting vehicles that are extremely close.

In omnidirectional signaling mode, the LSS vehicle mounted illuminator is configured for mapping and selection where all vehicles with range are illuminated, transmitting and responding to MPPPoX discovery packets. During MPPPoX discovery and session stages, the vehicle identifier, location and heading of each AV within a specified range is obtained and mapped on a display relative to the law enforcement vehicle. The desired vehicle or vehicles can then be selected and command transmit.

In an alternate embodiment the Remote User Interfaces 1321 may be configured to support a personal identification number (PIN) entry pad to support multi-factor authentication of the entity using the LSS vehicle mounted illuminator in conjunction with the Smart Card Reader Interface 1329. The smart card reader may be provided for U.S. DOD usage, U.S. Federal usage, or other high security environments where a Personal Identification Verification (PIV) card, a PIV-Interoperable (PIV-I) card, a Common Access Card (CAC), or other smart card must be used to provide the multi-factor authentication necessary to use the LSS vehicle mounted illuminator in that environment.

In another alternate embodiment, a Peer-to-Peer Receiver 1335 may implement a communication technology such as 802.11 (V2V, V2I) or other comparable technologies to obtain the location and unique identifier of all autonomous vehicles within range. These vehicles are displayed on a map relative to the law enforcement vehicle. The underlying communication protocol may implement message confidentiality, message integrity, end-point mutual authentication, reliability, and non-repudiation. The receiver beam pattern of the Peer-to-Peer Receiver Antenna 1340 is approximately omnidirectional, and depending on receiver sensitivity and transmit power, is limited to approximately a one (1) kilometer radius. The mapping function will apply filters to limit the vehicles to those of interest, e.g., range and route.

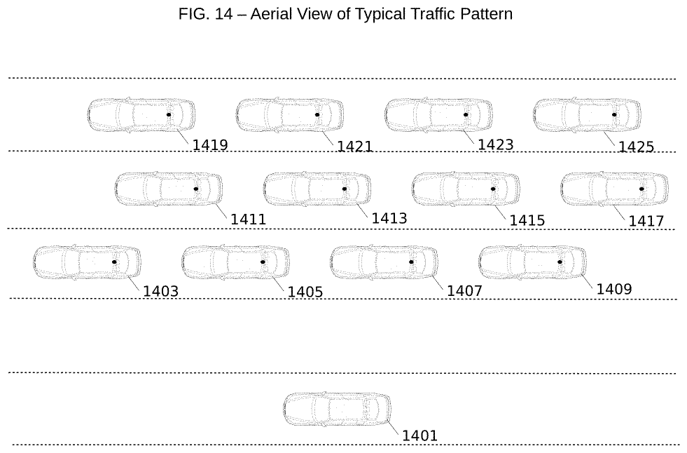

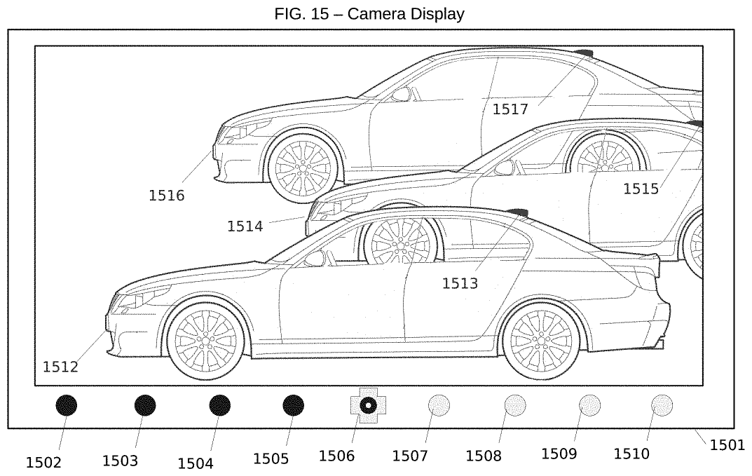

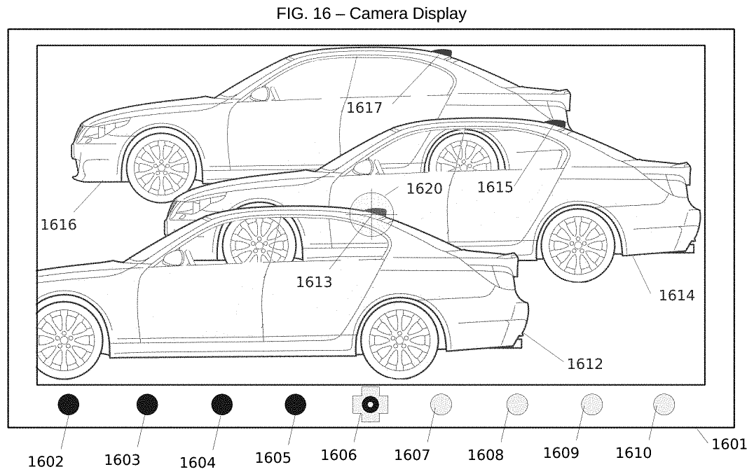

With reference now to FIG. 14, FIG. 15, and FIG. 16 diagrams depicting a traffic pattern on a multi-lane highway in three representations. In FIG. 14 the diagram depicts an aerial view of a traffic pattern on a typical roadway. Depicted is a law enforcement vehicle 1401, and a plurality of nearby autonomous vehicles 1403, 1405, 1407, 1409, 1411, 1413, 1415, 1417, 1419, 1421, 1423, and 1425. The following figures, FIG. 15 and FIG. 16 show the traffic of interest from a camera on the LSS illuminator beam axis located on law enforcement vehicle 1401.

In FIG. 15, the diagram depicts a touch panel display 1501 located within law enforcement automobile (not shown) showing a camera view of the nearby autonomous vehicles 1512, 1514, and 1516, with AV LSS Transducers 1513, 1515, 1517, push button controls 1502, 1503, 1504, 1505, a joystick 1506, and indicators 1507, 1508, 1509, and 1510. In this depiction, the LSS Automobile Mounted illuminator is operating in camera mode. The joystick 1506 is used to control the azimuth and elevation of the LSS vehicle mounted illuminator, allowing the camera to pan the scene. The operator selects a target vehicle by touching the display on one of AV LSS Transducer 1513, 1515, or 1517, causing the LSS vehicle mounted illuminator to slew to that position.

In FIG. 16, the diagram depicts the touch panel display 1601, showing a camera view of the nearby autonomous vehicles 1612, 1614, and 1616, with AV LSS Transducers 1613, 1615, 1617, push button controls 1602, 1603, 1604, 1605, a joystick 1606, and indicators 1607, 1608, 1609, and 1610.

In this depiction, the touch panel display shows what results when the operator has touched (short touch) the screen over AV LSS Transducer 1613, causing the LSS Automobile Mounted illuminator to immediately recenter the display on AV LSS Transducer 1613, display a target reticle 1620 over the AV LSS Transducer 1613 and initiate communication which will cause the AV LSS Transducer 1613 strobe to activate. Once the strobe is activated, the LSS illuminator optical tracking algorithm controls the azimuth and elevation to maintain focus on the AV LSS Transducer 1613 until the operator terminates the session.

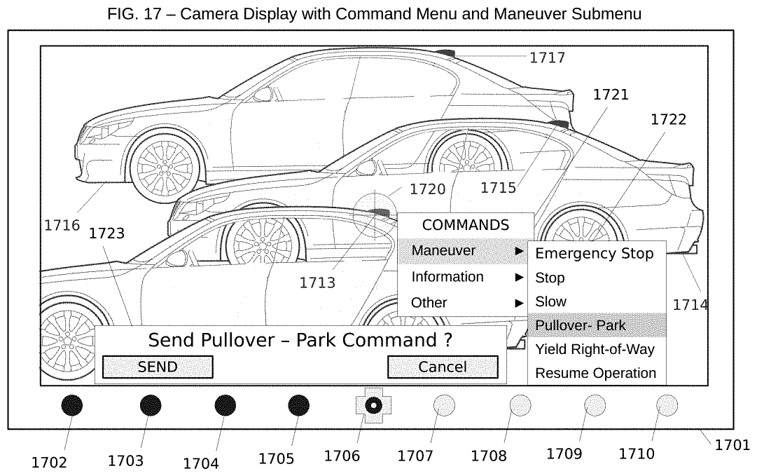

In FIG. 17, the diagram depicts the touch panel display 1701, showing a camera view of the nearby autonomous vehicles 1712, 1714, and 1716, with AV LSS Transducers 1713, 1715, 1717, push button controls 1702, 1703, 1704, 1705, a joystick 1706, and indicators 1707, 1708, 1709, and 1710.

In this example interaction, the touch panel display 1701 shows what results when the operator has touched and held (long touch) the screen over AV LSS Transducer 1713, causing the display of a target reticle 1720 over AV LSS transducer 1713, and a command menu 1721 to display for command entry. Sliding a finger over the command menu 1721 item “Maneuver” results in the display of the maneuver sub-menu 1722. Selection of the command “Pullover—Park” causes a confirmation panel be displayed which will transmit the “Pullover—Park” command upon pressing “Send” or command cancellation if “Cancel” is pressed. In this manner, all commands are available to the operator.

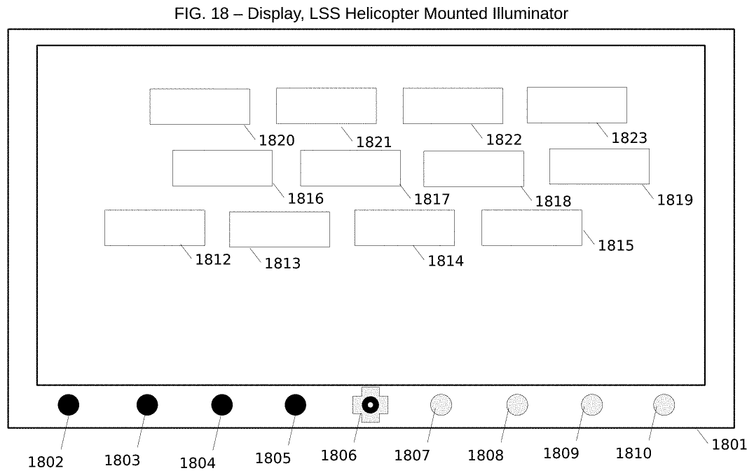

With reference now to FIG. 18, a diagram depicting an aerial view of a typical traffic pattern on a multi-lane highway. FIG. 18 depicts a display showing an aerial map of autonomous vehicles in the field of view of a helicopter employing a LSS helicopter mounted illuminator in accordance with a preferred embodiment of the present invention. The touch panel display 1801 displays symbols representing the outlines of the vehicles in the LSS illuminator camera field of view processed with edge detection software. The display is located within the law enforcement helicopter (not shown) showing the autonomous vehicles 1812 through 1823, push button controls 1802, 1803, 1804, 1805, a joystick 1806, and indicators 1807, 1808, 1809, and 1810. In this depiction, autonomous vehicles 1803 through 1823 have been mapped with edge detection software showing only vehicle outlines.

In the preferred embodiment of the invention, when law enforcement personnel touches the display over the vehicle 1817 outline, the system will steer the LSS illuminator focused optical beam to vehicle 1817, illuminating the vehicle's AV LSS Transducer within the illuminator beam and transmit a command message that only vehicle 1817 is able to detect because of the narrow optical beamwidth. Receipt of the command causes the LSS override controller to activate a tracking strobe in the AV LSS Transducer which the LSS helicopter mounted illuminator then tracks to assist stable targeting.

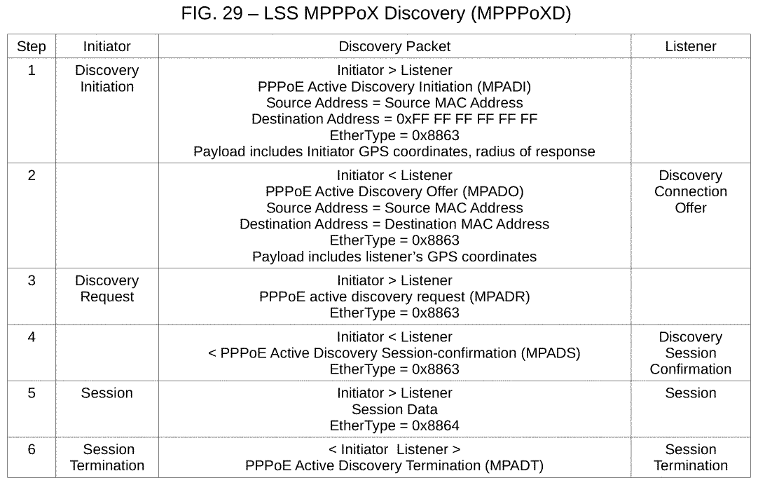

In an alternate embodiment, the LSS illuminator employs an omnidirectional RF antenna using a modified Point-to-Point Protocol over Xmedia (MPPPoX) active discovery request (MPADR) to identify all autonomous vehicles within a specified range. Identification includes the GPS coordinates and vehicle IDs which are then mapped on the touch display. When law enforcement personnel touches a vehicle outline, the vehicle ID is selected and a command menu is displayed, allowing the system transmit the specified command message (with vehicle ID) with a RF beam so only the vehicle with that ID responds. MPPPoX and MPADR are described in the discussion of FIG. 29.

In another alternate embodiment, the positions of autonomous vehicles 1812 through 1823 are provided using the GPS coordinates and vehicle IDs obtained from the peer-to-peer receiver. When law enforcement personnel touches a vehicle outline, the system will transmit a command message (with vehicle ID) with a directed RF beam so only the vehicle with that ID responds.

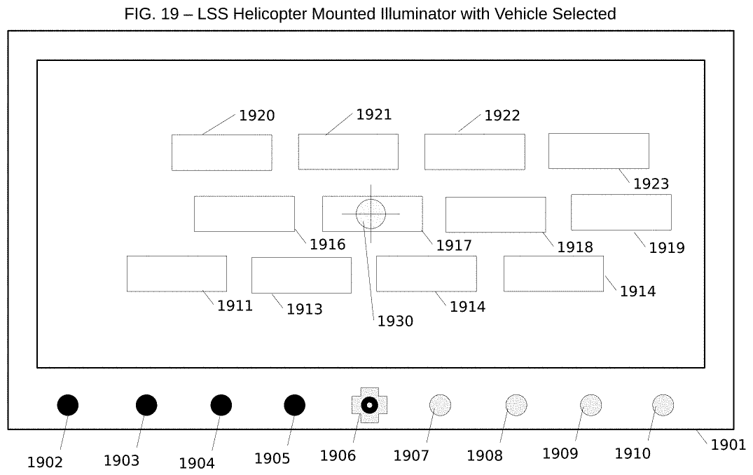

With reference now to FIG. 19, a diagram depicting a touch panel display showing an aerial map of autonomous vehicles in the field of view of the helicopter employing a LSS helicopter mounted illuminator. The diagram depicts a touch panel display 1901, showing the autonomous vehicles 1912 through 1923, push button controls 1902, 1903, 1904, 1905, a joystick 1906, and indicators 1907 1908, 1909, and 1910. In this depiction, autonomous vehicles 1912 through 1923 have been mapped with edge detection software showing only vehicle outlines.

In this depiction, the touch panel display shows what results when the operator has touched the screen over vehicle 1917, causing the LSS helicopter mounted illuminator to immediately recenter the display on vehicle 1917, display a target reticle 1930 over vehicle 1917 and initiate communication.

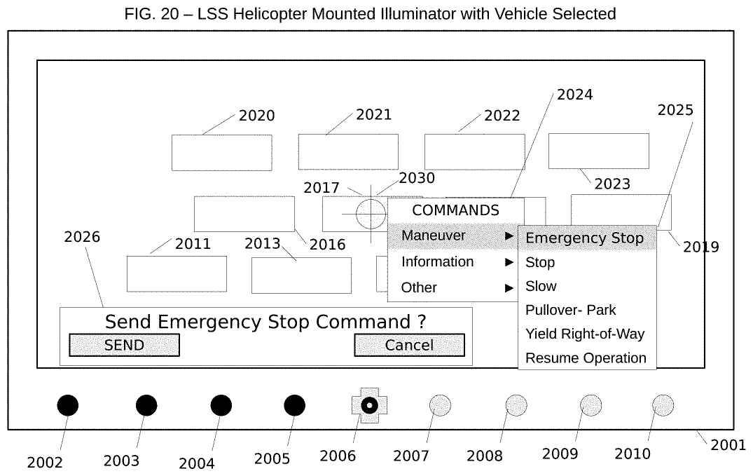

With reference now to FIG. 20, a diagram depicting a touch panel display showing an aerial map of autonomous vehicles in the field of view of the helicopter employing a LSS helicopter mounted illuminator. The diagram depicts a touch panel display 2001, showing the autonomous vehicles 2012 through 2023, push button controls 2002, 2003, 2004, 2005, a joystick 2006, and indicators 2007 2008, 2009, and 2010. In this depiction, autonomous vehicles 2003 through 2023 have been mapped with edge detection software showing only vehicle outlines.

In this depiction, the touch panel display 2001 shows what results when the operator has touched and held (long touch) the screen over AV 2017, causing the display of a target reticle 2030 over AV 2017, command menu 2024 to display for command entry. Sliding a finger over the command menu 2024 item “Maneuver” results in the display of the maneuver sub-menu 2025. Selection of the command “EmergencyStop causes a confirmation panel 2026 be displayed which will transmit the “EmergencyStop” command upon pressing “Send” or command cancellation if “Cancel” is pressed. In this manner, all commands are available to the operator.

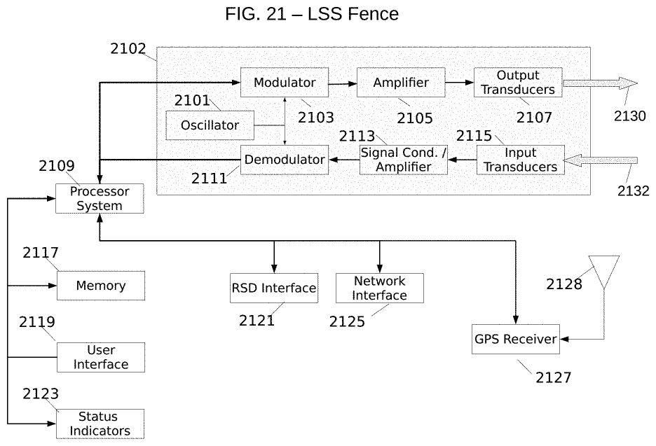

With reference now to FIG. 21, a block diagram illustrating components of a LSS Fence used by authorized personnel to mitigate and/or prevent autonomous vehicle misuse is depicted in accordance with a preferred embodiment of the present invention. The LSS Fence described herein communicates directly with the LSS override controller via the AV LSS Transducer. A LSS Fence may be located at fixed or mobile locations. In this illustrative example, the components organized into the following subsystems: processing, transmit chain, receive chain, user interface and network interface. Those of ordinary skill in the art will appreciate that the hardware depicted in FIG. 21 may vary; e.g., other components may be used in the transmit and/or receive chain, or other subsystems.

The transmit/receive chain 2102 includes Oscillator 2101 which generates the carrier frequency for RF transducers and the signaling frequency of optical and acoustic transducers, the Modulator 2103 which modulates the signal, Amplifier 2105 which amplifies the signal, the output transducers 2107 which comprises one or more of an optical, acoustic, or RF emitter that emits the modulated beam 2130 intended for the AV LSS Transducer. The transmit/receive chain 2102 also includes input transducer 2115 which comprises one or more of an optical, acoustic, or RF sensor that receives the modulated beam 2132, Signal Conditioner and Amplifier 2113 which synchronizes to the incoming signal and amplifies to the proper level, and Demodulator 2111 which recovers the information content from the modulated signal and sends for processing.

The transmit signal 2130 and the received signal 2132, are converted to/from electrical signals using transducers 2107 and 2115. These transducers may be one of or more of acoustic, optical, or radio frequency (RF) energy. Acoustic energy may be transduced by a piezoelectric device, a magnetostrictive device or other acoustic transducer. RF energy may be transduced by one or more of: a Yagi-Uda antenna, a monopole or a dipole antenna, a parabolic, or other suitable RF antenna. Optical energy may be emit by Light Emitting diode (LED), visible laser, infrared laser or other optical emitter and sensed by a photo diode. In some embodiments, the optical frequency of the optical transducers may fall within an atmospheric absorption frequency band such as between 1.3 microns to 1.4 microns or between 1.8 micron and 1.95 microns reducing potential susceptibility to sunlight saturation.

The processing chain is comprised of Processor 2109, Memory 2117, and RTC (not shown). The Processor 2109 performs all processing tasks including time keeping using the RTC updated by NTP at startup and periodically thereafter, generating transmit signals, interpreting receive signals, user input/output functions, and interfacing to dispatch; it interfaces to Memory 2117 where program and data are stored, interfaces to Removable Storage Device Interface 2121 which provides means to load necessary system data, reads user Input via user interface 2119, drives Status Indicators 2123, and drives the Network Interface 2125 which ensures all LSS Fence usage is externally monitored to preserve usage records. For mobile fence applications, a GPS Receiver 2127 and GPS Antenna 2128 is integrated. It is recommended high-accuracy GPS be implemented.

The Network Interface 2125 allows remote program code updates, certificate management including CRL or OCSP certificate revocation, remote audit server access, Network Time Protocol (NTP), and other required functions where all Internet access must have white-listed addresses.

The Remote User Interfaces 2119 may be configured as a local or a remote interface supporting SSH, HTTPS, or other secure communication technology for administrative purposes, where the interface is logically and physically distinct from the Network Interface 2125.

The “Fence” command is programmable via a secure remote administrative interface by the owning jurisdiction and includes the GPS coordinates of the restricted area and a set of restriction or allowance criteria specifying parameters associated with the restricted area, e.g., time and date, vehicle class, vehicle height, width, length, and current gross vehicle weight (GVW).

To increase reliability, at startup the LSS Fence performs a self test of each component and sensor. This check includes validation of all certificates including a CRL or OCSP check of certificate revocations status and ensuring the enclosure physical security mechanisms are functional. Additionally, the current CRL is downloaded from the appropriate CA. A failure of any component results in the vehicle being removed from service until resolved. Upon completions, the self-test results are transmit to the law enforcement dispatch.

LSS Fence installations may be fixed permanent installations, fixed temporary installations, or mobile installations. For example, a fixed Fence may be installed

The LSS fence is similar in purpose to the LSS illuminator with similar hardware; however, packaging and antennas are significantly different. Packaging is intended for a fixed or mobile (temporary) locations, there are no requirements for being handheld or steerable. The antennas are semi-customized for each installation, selecting from several different beam patterns. The supported antennas are omnidirectional, restricted beam width of 10, 20, 30, and 60 degrees.

The LSS fence software is significantly different from the LSS illuminators as the LSS Fence transmits only the single “Fence” command periodically; although, practical experience may require additional capability be added. The “Fence” command includes the GPS coordinates and possible authorization override criteria of associated restricted area. The authorization override allows some autonomous vehicles enter the restricted area without intervention from the override controller. i.e., a military base may allow selected commercial vehicles possessing a valid X.509 certificate issued by a DOD CA but exclude all civilian vehicles.

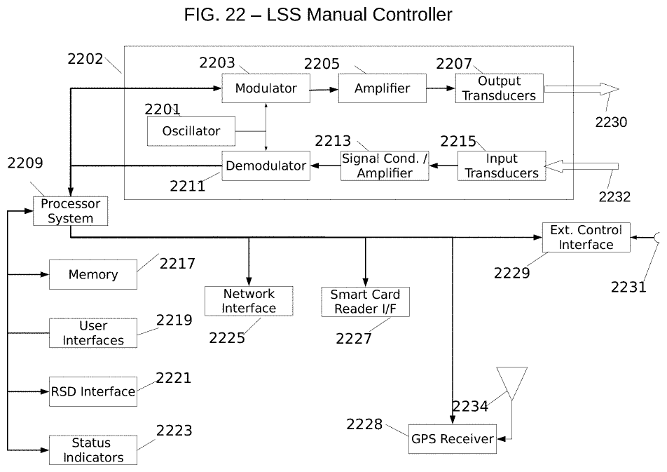

With reference now to FIG. 22, a diagram illustrating components of an LSS manual controller intended to communicate with the LSS override controller and used to manage the autonomous vehicle is depicted in accordance with a preferred embodiment of the present invention. The LSS manual controller described herein communicates directly with the LSS override controller via a wired or wireless link; the details are not illustrated. In this illustrative example, the components organized into the following subsystems: processing, transmit/receive chain, and user interface. Those of ordinary skill in the art will appreciate that the hardware depicted in FIG. 22 may vary; e.g., other components may be used in the transmit and/or receive chain, or other subsystems.

The transmit/receive chain 2202 includes Oscillator 2201 which generates the carrier frequency for RF transducers and the signaling frequency of optical and acoustic transducers, the Modulator 2203 which modulates the signal, Amplifier 2205 which amplifies the signal, the output transducers 2207 which comprises one or more of an optical, acoustic, or RF emitter that emits the modulated signal 2230 to the LSS override controller, either via wired or wireless means. The transmit/receive chain 2202 also includes input transducers 2215 which comprises one or more of an optical, acoustic, or RF emitter receives the modulated signal 2232 from the LSS override controller. Signal Conditioner and Amplifier 2213 which synchronizes to the incoming signal and amplifies to the proper level, and Demodulator 2211 which recovers the information content from the modulated signal and sends for processing.

The transmit signal 2230 and the received signal 2232, are converted to/from electrical signals using transducers (not shown) mounted on the LSS manual controller. These transducers may be one or more of acoustic, optical, or radio frequency (RF). Acoustic energy may be transduced by a piezoelectric device, a magnetostrictive device or other acoustic transducer. RF energy may be transduced by one or more of: a Yagi-Uda antenna, a monopole or a dipole antenna, a parabolic, or other suitable RF antenna. Optical energy may be emit by Light Emitting diode (LED), visible laser, infrared laser or other optical emitter and sensed by a photo diode. In some embodiments, the optical frequency of the optical transducers may fall within an atmospheric absorption frequency band such as between 1.3 microns to 1.4 microns or between 1.8 micron and 1.95 microns reducing potential susceptibility to sunlight saturation.

The processing chain is comprised of Processor 2209, Memory 2217 and RTC (not shown), the Processor 2209 performs all processing tasks including time keeping using the RTC updated by NTP at startup and periodically thereafter, generating transmit signals, interpreting receive signals, user input/output functions, interfacing to law enforcement dispatch via Network Interface 2225; it interfaces to Memory 2217 where program and data are stored, interfaces to Removable Storage Device Interface 2221 which provides means to load necessary system data, reads User Interface 2219, drives Status Indicators 2223, interfaces to the External Control Interface 2229, GPS Receiver 2228, and Smart Card Reader 2227. The GPS Receiver 2228 and GPS Antenna 2234 provide accurate location data. The User Interface 2219 and Status Indicators 2223 may be integrated into a touch display tablet for ease of operation.

The External Control Interface 2229 provides direct wired connectivity to a LSS manual controller to send commands to the LSS override controller to assert control over the AV directly, overriding all functionality of the native AV ADS controller. The LSS manual controller connects using connector/cable 2231 which connects to the exterior of the AV. When connector/cable 2231 is connected and connection established, AV LSS Transducers 2207 and 2215 are disabled until the LSS manual controller disconnected. The External Control Interface 2229 employs the TLS protocol using FIPS approved algorithms to provide secure connectivity, i.e., message confidentiality, message integrity, mutual identification and authentication, reliability, forward secrecy and non-repudiation.

When LSS manual controller is activated it initiates a TLS handshake with mutual authentication; immediately after the handshake is completed, the LSS manual controller transmits command(s) and waits on a response from the LSS override controller. When the command(s) are acknowledged, the LSS manual controller issues a TLS shutdown command to terminate the link; this ends the TLS session. Those of ordinary skill in the art will appreciate that protocols other than TLS may be used to achieve the necessary link security.

Typical necessary commands (or their equivalent) that are envisioned are the proportional commands, “PullForward”, “BackUp”, “TurnLeft”, and “TurnRight” and fixed commands, “Stop”, “DownloadVehicleIdentification”, “UnlockLoadCompartment”, “ContactTerminal”, “Train”, and “ResumeOperation”; proportional commands carry rate information and are used to move the vehicle locally at low rates of speed.

The command “Stop” is issued in situations that require immediate AV halt.

The command “DownloadVehicleIdentification” is intended for situations where vehicle inspection requires the vehicle produce documentation such as: identification (the motor carrier's name or trade name and the motor carrier's Department of Transportation (DOT) registration number, manifest, proof of insurance, maintenance records, accident records, licenses, permits, planned route and actual route, etc.; this information is downloaded to the controller's Removable Storage Device drive for review and storage.

The command “UnlockLoadCompartment” is used to unlock the vehicle cargo bay so law enforcement may perform vehicle load inspections. An AV owned and operated by designated entities such as the U.S. Government may be exempt from this command to avoid exposing information that may compromise national security; however, these vehicles must provide proper identification of exempt status using special X.509 PKI certificates.

The command “ContactTerminal” is intended to notify the vehicle's owner/operator that additional assistance is required.

The command “ResumeOperation” is intended to allow the AV continue its operation after interruption; however, no internal AV ADS control may be applied until enabled by receipt of this command. Those of ordinary skill in the art will appreciate that design requirements, regulatory requirements, field experience, etc., may require commands be added, modified, and/or removed.

To increase reliability, at startup the LSS manual controller performs a self test of each component and sensor. This check includes validation of all certificates including a CRL or OCSP check of certificate revocations status and ensuring the enclosure physical security mechanisms are functional. Additionally, the current CRL is downloaded from the appropriate CA. A failure of any component results in the LSS manual controller being removed from service until resolved with visual indication by status indicators. Upon completions, the self-test results are transmit to the law enforcement dispatch via Network Interface 2225.

In an alternate embodiment the LSS manual controller enclosure (not shown) provide protection of internal memory, including one or more of evidence of tampering, physical security mechanisms, or physical security mechanisms providing a complete envelope of protection around the enclosure with the intent of detecting and responding to all unauthorized attempts at physical access.

In another alternate embodiment the LSS manual controller enclosure (not shown) is designed to defeat or mitigate the threat of an electromagnetic pulse (EMP), an intentional electromagnetic interference (IEMI) event, or a geomagnetic disturbance (GD).

In an alternate embodiment the User Interfaces 2219 may be configured to support a personal identification number (PIN) entry pad to support multi-factor authentication of the entity using the LSS manual controller in conjunction with the Smart Card Reader Interface 2227. The smart card reader may be provided for U.S. DOD usage, U.S. Federal usage, or other high security environments where a Personal Identification Verification (PIV) card, a PIV-Interoperable (PIV-I) card, a Common Access Card (CAC), or other smart card must be used to provide the multi-factor authentication necessary to use the LSS manual controller in that environment.

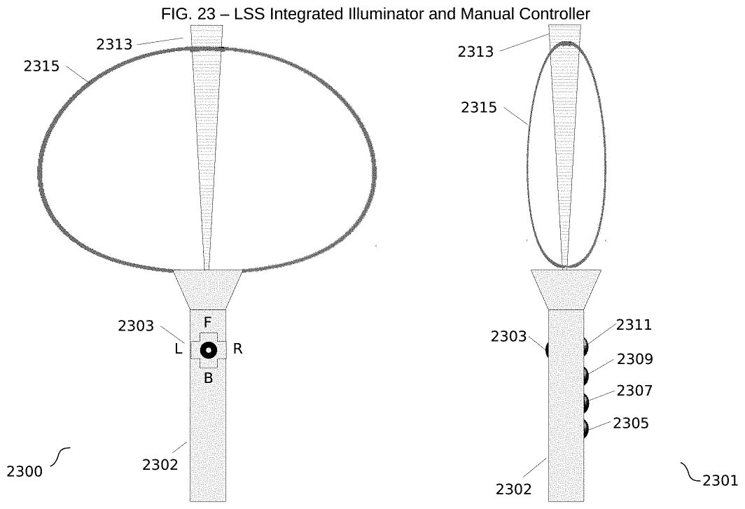

With reference now to FIG. 23, a depiction of two views, 2300 and 2301, of an integrated LSS Handheld illuminator and LSS manual controller (illuminator/manual controller) 2302 that provides increased AV control and reliability in an alternate embodiment of the invention. View 2300 shows a top view of the LSS illuminator/manual controller 2302 with joystick control 2303, concentrated optical beam 2313 and RF beam 2315. View 2301 shows the controls 2303, 2305, 2307, 2309 and 2311 that are used to control the LSS illuminator/manual controller functions. Also shown are the, concentrated optical beam 2313 and RF beam 2315.

Commands available to the LSS Handheld illuminator functions are “Acknowledge”, “EmergencyStop”, “Stop”, and “ResumeOperation”. Using controls 2303, 2305, 2307, 2309 and 2311, the LSS Handheld illuminator transmits a first set of commands to identify and stop an AV via a focused optical beam 2313 to the AV LSS Transducer on the AV (not shown) which is processed by the LSS override controller.

The “Acknowledge” command causes the activation of a strobe light in the LSS transducer mounted on the AV, providing visual confirmation the LSS override controller received the command.

The “Stop” or “EmergencyStop” command is used to halt the AV as appropriate. Additionally, the LSS Handheld illuminator obtains the vehicle ID from the LSS override controller during the handshake that is used by the LSS manual controller, allowing the LSS manual controller be used to maneuver the AV once the AV has come to a complete halt. View 2301 shows the joystick control 2303 that is used to control the LSS manual controller functions. Joystick controller 2303 activates commands “PullForward”, “BackUp”, “TurnLeft”, and “TurnRight”; however, control 2303 is inactive until the AV has been halted and vehicle ID obtained. The LSS manual controller employs a wide RF beam 2315 (not shown to scale) or a focused acoustic beam (not shown) allowing more flexible targeting of the AV.

In an alternate embodiment the integrated LSS Handheld illuminator and LSS manual controller 2302 enclosure provide protection of internal memory, including one or more of evidence of tampering, physical security mechanisms, or physical security mechanisms providing a complete envelope of protection around the enclosure with the intent of detecting and responding to all unauthorized attempts at physical access.

In another alternate embodiment the integrated LSS Handheld illuminator and LSS manual controller 2301 enclosure is designed to defeat or mitigate the threat of an electromagnetic pulse (EMP), an intentional electromagnetic interference (IEMI) event, or a geomagnetic disturbance (GD)

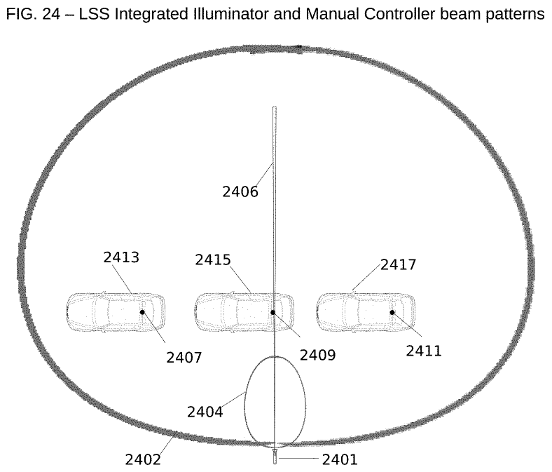

With reference now to FIG. 24, a diagram depicting the beam patterns of a LSS illuminator, or a LSS Integrated illuminator and manual controller in accordance with a preferred embodiment of the present invention. The integrated illuminator and manual controller 2401 operates in three remote modes, focused acoustic beam 2404, wide RF beam 2402, and focused optical beam 2406. In each case, the beam patterns depicts the 1% power point of the each beam. In focused acoustic beam mode, acoustic beam 2404 distance is limited requiring the target vehicle be close in proximity. In wide beam RF mode the RF beam 2402 illuminates AV LSS Transducers 2407, 2409, and 2411 on all three vehicles 2413, 2415, and 2417 and therefore must be used in sparse traffic environments or when all nearby AVs are to be intentionally signaled. In focused optical beam mode, the optical beam 2406 is able to select a single vehicle even in closely spaced traffic. In this example, only the AV LSS Transducer 2409 on AV 2415 has been illuminated with the focused optical beam 2406.

With reference now to FIG. 25, a depiction of a LSS illuminator 2502 showing a visible light pointing aid in the preferred embodiment of the invention. The visible pointing aid is comprised of a concentrated center beam 2504 and a diffuse conical beam 2503, both on the same axis as the signaling beam of LSS illuminator 2502. The diffuse cone 1% angle 2510 may be fixed or variable. The target is illuminated with the diffuse cone 2513 and concentrated beam 2514, allowing improved targeting when the concentrated center beam misses the target and therefore a reflection is not visible.

In an alternate embodiment of the invention, the center beam 2504 may be implemented as a laser range finder where the range is used to modify the LSS transducer power output.

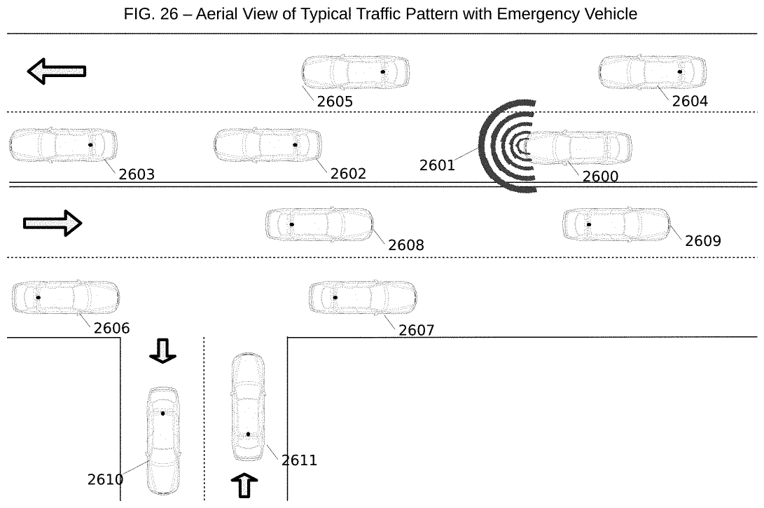

With reference now to FIG. 26, a diagram depicting an aerial view of a typical traffic pattern on a multi-lane highway with an emergency vehicle and LSS emergency vehicle illuminator emissions 2601. Also shown are AVs 2602, 2603, 2604, and 2605, traveling in the same direction on the same roadway, AVs 2606, 2607, 2608, and 2609, traveling in the opposite direction on the same roadway, and AVs 2610 and 2611, traveling on a perpendicular roadway. All AVs shown are within the transmission distance of the LSS emergency vehicle illuminator emissions 2601; however, only AVs 2602 and 2603 are required to yield right-of-way to the approaching emergency vehicle 2600.

In operation, emergency vehicle 2600 periodically broadcasts a “Yield” command with at least it's GPS coordinates, radius of required response, speed, and route. Additionally, as part of the “Yield” command packet protocol, the “MAC Address field” is set to BROADCAST and the “Type” field set to “LSS emergency vehicle controller” as specified in Table 1. Also during the command protocol, the emergency vehicle transmits it's PKI certificate to validate it has authority to issue a “Yield” command.

Each AV LSS override controller receiving the message first validates the message parameters including the “type” field. Assuming a valid message in this case and since the “Type” field set to “LSS emergency vehicle controller” the LSS override controller performs a calculation to determine the AV's position relative to the emergency vehicle 2600 to determines if they are within the radius of required response and on the emergency vehicle's route and therefore required to yield. If required to yield, the LSS override controller will request the AV's ADS yield right-of-way, if not required, the command is ignored. Once the AV's calculation determines the AV is no longer in the path of the emergency, and a safe following distance has been achieved, the LSS override controller may issue a resume command to the ADS. Those of ordinary skill in the art will appreciate that the safe following distance may vary by vehicle type, nominal speed and jurisdiction.

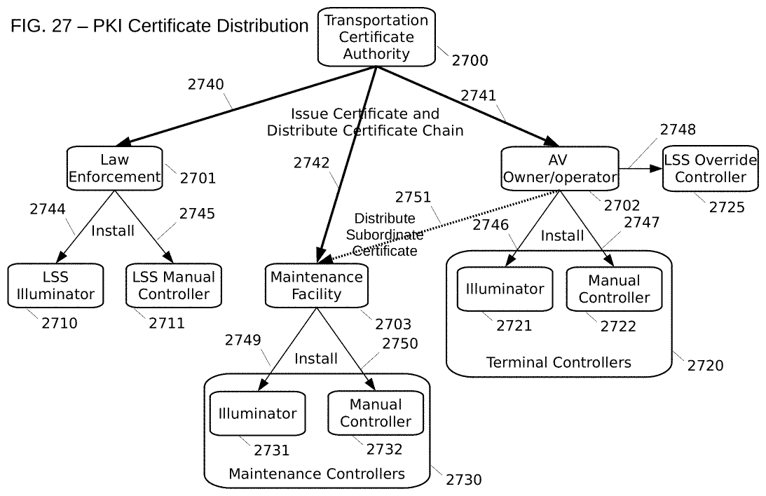

With reference now to FIG. 27, a diagram depicting the PKI Certificate Distribution process in the preferred embodiment of the invention. In this example, the Transportation Certificate Authority 2700 is the Certificate Authority (CA) that issues certificates and distributes the certificate chain upon receipt of a Certificate Request (CSR) by either Law Enforcement 2701, an AV owner/operator 2702, and/or a Maintenance Facility 2703 as indicated by operations 2740, 2741, and 2742 respectively. Additionally, the Transportation Certificate Authority 2700 maintains a list of revoked certificates to support PKI CRL and/or OCSP. The Transportation Certificate Authority 2700 may be a Federal CA acting as the ROOT CA or State Level intermediate CA under the ROOT CA. Those of ordinary skill in the art will appreciate that additional intermediate levels are possible, e.g., state level CAs.

After receipt of the certificate chain, Law Enforcement 2701, the AV owner/operator 2702, and Maintenance Facility 2703 will install the certificate chain in their respective equipment. i.e., Law Enforcement 2701 will install the certificate chain in the LSS Illuminator 2710 and LSS Manual Controller 2711 as indicated by operations 2744 and 2745 respectively. Similarly, the AV owner/operator 2702 will install the certificate chain in the LSS Illuminator 2721, LSS Manual Controller 2722, and LSS Override controller 2725 as indicated by operations 2746, 2747, and 2748 respectively and the Maintenance Facility 2703 will install the certificate chain in the Illuminator 2731 and Manual Controller 2732 as indicated by operations 2749 and 2750 respectively.

In the preferred embodiment of the invention, the AV LSS override controller 2725 will respond only to commands issued by a device (illuminator or manual controller) with a valid certificate traceable to the Transportation Certificate Authority 2700.

In an alternate embodiment of the invention, the AV owner/operator 2702 may issue a (temporary) subordinate certificate with limited duration to the Maintenance Facility 2703 as indicated by operations 2751 as a requirement for the facility to maneuver an AV for maintenance purposes. In this embodiment, the AV LSS override controller 2725 would require a valid subordinate certificate issued by the owner/operator traceable to the Transportation Certificate Authority 2700.

In another alternate embodiment, the AV LSS override controller 2725 would require a both a valid subordinate certificate issued by the owner/operator traceable to the Transportation Certificate Authority 2700 as well as a valid certificate issued to the maintenance facility traceable to the Transportation Certificate Authority 2700.

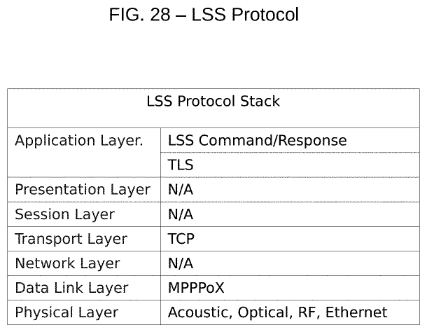

With reference now to FIG. 28, a depiction of the LSS Protocol stack in terms of the Open Systems Interconnection (OSI) model. The LSS Protocol is a Modified Point-to-Point Protocol (MPPP) over Xmedia (MPPPoX) employed for communication between a LSS external controller and a LSS override controller, where the physical media (Xmedia) may be optical, RF, acoustic or Ethernet depending on the signaling mode. The Application layer comprises the LSS Application Command/Response code running on top of TLS. The Presentation and Session layers are unused. The Transport layer is Transmission Control Protocol (TCP); because there is no routing information required, the Network layer is unused. The Data Link Layer is a Modified Point-to-Point Protocol over Xmedia (MPPPoX) and the Physical Layer may be optical, RF, acoustic or Ethernet depending on the signaling mode

With reference now to FIG. 29, a depiction of the LSS MPPPoX Discovery (MPPPoXD) process consisting of five steps between the initiator (LSS external controller and the listener (LSS override controller). In discovery packets the EtherType field is set to 0x8863 (Discovery Stage). After discovery, the PPP connection has an established session, the EtherType field is set to 0x8864 (PPP Session Stage).

In Step 1, the LSS discovery phase begins when the initiator (LSS external controller) transmits a MPPPoX Active Discovery Initiation (MPADI) packet that includes at least it's MAC address, required radius of response, and GPS coordinates. Although actual implementation details may vary by command and LSS external controller type, the GPS coordinates allow the distance to initiator be calculated to determine if the listener (AV) is required to respond. If the AV is not required to respond to the MPADI (based on the command and type), the packet is silently discarded.

In Step 2, the response from the listener is a MPPPoX Active Discovery Offer (MPADO) packet which includes at least it's MAC address and GPS coordinates. When the LSS System is in the focused optical beam mode, the beam width is very small and allows focusing on an individual target vehicle during discovery, therefore, only a single response is expected. If multiple responses are received by the initiator, they are discarded and the discovery phase is restarted at Step 1.

In Step 3, a MPPPoX active discovery request (MPADR) is transmit to the initiator from a single listener. When the listener receives the MPADR, the AV LSS Transducer strobes may be activated to assist in active tracking.

In Step 4, the listener subsequently contacts the initiator using a MPPPoX Active Discovery Session-confirmation (MPADS) and assigns the device a session ID. The initiator is then connected to the listener.

In Step 5, if one of the participants wishes to terminate the connection, it communicates this to the other device with a MPPPoX Active Discovery Termination (MPADT).

Communication between a LSS external controller and a LSS override controller includes: vehicle selection stage, command/response stage, and termination stage. These stages may vary slightly according to the type of LSS external controller. The selection stage obtains the MAC address of the LSS override controller for use during command/response stage. The command/response stage transmits operator commands and receives responses from the LSS override controller. When all commands and responses are completed, the termination stage closes the connection.

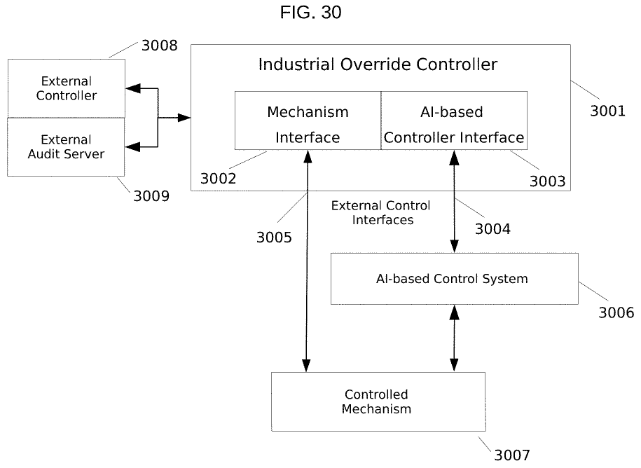

With reference now to FIG. 30, a block diagram of an industrial override controller 3001, AI-based controller 3006, a controlled mechanism 3007, External Controller 3008 and External Audit Server 3009. in accordance with an alternate embodiment of the present invention. The override controller 3001 is deterministic, configured to independently monitor the behavior, enforce operational limitations, record audit records of attempts to exceed any operational limitation, and record audit records of hardware or software failures, of the AI-based control system 3006 and the controlled mechanism 3007.

Override controller 3001 includes a mechanism interface module 3002 and an AI-based controller interface module 3003, both of which are customizable, allowing the industrial override controller interface to different manufacturer's AI-based controller and controlled mechanism. These interface modules may be implemented entirely by hardware, or by hardware and software controlled by an independent microprocessor. Also shown is the external control interfaces 3004 and 3005, both of which are customizable for each manufacturer's equipment. The AI-based controller interface 3004 interfaces directly to the AI-based control system 3006, and communicates directly with the control system computer to monitor it's behavior and can assert unconditional control over the AI-based controller and, if necessary, bypass it to assert unconditional control over the mechanism being controlled via the mechanism control interface 3005. Additionally, the override controller 3001 can remove power from, or reboot the AI-based control system 3006 if necessary. The mechanism control interface 3005 interfaces directly to the controlled mechanism 3007 and can assert unconditional control over it, including it's power system.

The override controller 3001 may be programmed via the External Controller 3008 to establish the limitations of both the AI-based control system 3006 and controlled mechanism 3007. Any metric can be used to establish an envelope of performance, and as long as the override controller has the appropriate sensor system to detect the appropriate metric, it can monitor the behavior. As long as the override controller 3001 has the appropriate controls to manipulate the metric, it can enforce the desired operational limitations. In the extreme case the AI-based control system 3006 or the controlled mechanism 3007 fail to respond appropriately to the applied control, the override controller 3001 will remove power from one or both. All interactions between the External Controller 3008 and AI-based control systems 3006, all attempts by the AI-based control systems 3006 or the controlled mechanism 3007 to exceed any operational limitation, and any hardware or software failures of the AI-based control systems 3006 or the controlled mechanism 3007 will be included in the audit records written to the External Audit Server 3009.

The communication protocol between the Industrial Override Controller 3001 and External Controller 3008 and External audit server 3009 employs the TLS protocol over TCP/IP to ensure guaranteed delivery. Additionally, FIPS approved algorithms are employed to provide secure connectivity, i.e., message confidentiality, message integrity, mutual identification and authentication, reliability, forward secrecy, and non-repudiation. Identification and authentication may employ Public Key Infrastructure (PKI) X.509 certificates issued by a Certificate Authority (CA).

The External Audit Server 3009 is a specialized server that receives, stores, protects, and displays audit records received from the Industrial Override Controller 3001 and External Controller 3008. Additionally, audit records may be exported from the audit server with security attributes to provide records for non-repudiation. Audit records also help monitor security-relevant events, and act as a deterrent against security violations. Audit functions include a defined audit record format and audit data protection. The audit record is presented in human-readable format either directly (e.g. storing the audit trail in human-readable format) or indirectly (e.g. using audit reduction tools), or both. Additionally, audit analysis tools, violation alarms, and real-time analysis may be available. Analysis tools allow large volumes of audit records be searched for particular events of interest. A violation alarm can be set to automatically inform an authorized user (of the audit server) that a particular event has occurred, e.g., a alarm could be set to detect when a particular error has occurred.

The controlled mechanism 3007 may be an automobile, an unmanned aircraft, an industrial robot, a wheelchair, industrial process equipment, or any other mechanism that requires a computerized AI-based control system. The controlled mechanism may also refer to the AI-based system itself, limiting the ability of the system to utilize unauthorized resources, communicate with unauthorized entities, perform actions deemed dangerous or destructive.

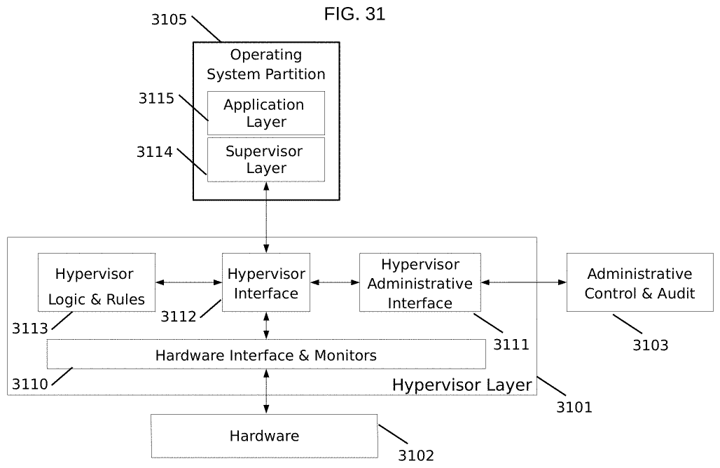

With reference now to FIG. 31, a block diagram depicting an industrial controller implemented as an Artificial Intelligence (AI) application with an override controller that independently monitor it's behavior, enforces it's operational limitations, record audit records of attempts to exceed any operational limitation, and record audit records of hardware or software failures of the AI-based application and the controlled mechanism. The AI-based application employs neural networks and machine learning algorithms to perform control of the controlled mechanism, whereas the override controller is strictly a deterministic controller.

The override controller executes in the hypervisor layer 3101 and the AI application, e.g., AI-based controller, executes in the Application Layer 3115 within the isolated operating environment of Operating System (OS) partition 3105. Depicted in FIG. 31 is the Hypervisor Layer 3101, Hardware 3102, Administrative Control and Audit 3103, and Operating System (OS) partition 3105. Hardware 3102 comprising the hardware the industrial controller executes as well as the mechanism controlled by the industrial controller as well as any sensors required by the industrial controller.

The hypervisor layer 3101 includes the hypervisor interface 3112, hypervisor administrative interface 3111, the hypervisor logic and rules 3113, and the hardware interface and monitors 3110. The hypervisor layer 3101 may run on the same physical processor or on a separate processor as the OS partition 3105. The hypervisor interface 3112 provides a well defined interface to the OS partition 3105 and provides the services by which hardware 3102 resources and the controlled mechanism must be accessed, including processing units (Microprocessor Processing Unit (MPU), Graphics Processing Unit (GPU), Tensor Processing Unit (TPU), etc.), memory controller, memory management unit, memory, all input/output devices such as non-volatile storage, removable storage, Local Area Network (LAN), Wide Area Network (WAN), etc.

The hardware interface and monitors 3110, monitors and maintains real-time control of all hardware resources under control of the hypervisor, allocating and deallocating the resources according to the hypervisor logic and rules 3113. The hardware interface and monitors 3110 may be comprised of both software and hardware as design and performance dictate.

The hardware interface and monitors 3110 independently monitors the behavior, enforces the operational envelope parameters established by the hypervisor logic and rules 3113, record audit records of attempts to exceed any operational envelope parameter, and record audit records of hardware or software failures of the Artificial Intelligence (AI) application(s) executing within Application Layer 3115.

The administrative control and audit 3103 provides an interface to control and administer the system, including establishing the hypervisor logic and rules 3113 as well as providing an external audit server to preserve and protect the audit trail. Control can be exerted directly through a command interface, primarily as a mechanism to intervene for emergency situations.

The OS partition 3105 provides an isolated environment for the supervisor layer 3114 and application layer 3115. Although only one operating system 3106 is shown in this example, those of ordinary skill in the art will appreciate that the hypervisor layer 3101 may support a plurality of operating systems, each executing in a separate protected domain. The supervisor layer 3114 and application layer 3113 may execute on the same processor as the hypervisor layer 3101 or on separate hardware. The supervisory layer 3114 presents an abstraction interface to the application layer 3115 such that the application layer 3115 has no knowledge of the hypervisor layer 3101.

In this example, the software executing on the application layer 3115 are Artificial Intelligence (AI) application(s) that may pose a threat given an unrestricted access to resources, therefore, the hypervisor layer 3301 may assert unconditional control over the AI software through the dynamic restriction of processing resources, memory, and communications, including LAN and WAN endpoints. Because the application layer 3115 has no knowledge of the hypervisor layer 3101, the Artificial Intelligence (AI) application(s) are unconditionally subject to the controls established by the Administrative Control 3103.

The descriptions of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law

### Definitions

| | |
|---|---|
| ADS | See Automated Driving System |
| Audit | Recognizing, recording, storing, and analyzing |
| | information related to relevant activities. |
| Authenti- | Verifying the identity of a user, process, or device, |
| cation | often as a prerequisite to allowing access to resources |
| | in an information system. |
| Authori- | The right or a permission that is granted to a system |
| zation | entity to access a system resource. |
| Automated | An automated driving system is generally an |
| Driving | integrated package of individual automated systems |
| System | operating in concert to assist a driver, take over some |
| | driving tasks, or take complete control of a vehicle. |
| AV | Autonomous Vehicle, for the purposes of this |
| | invention, refers to SAE specification J3016, Level 2 |
| | and higher vehicle, autonomous controlled aircraft, or |
| | other mobile device under autonomous control. |
| CAC | See Common Access Card |
| Certificate | The act of invalidating a certificate before its |
| Revocation | scheduled expiration date using CRLs, OCSP, or other |
| | means. |
| Certificate | A list of digital certificates that have been revoked by |
| Revocation | the issuing certificate authority (CA) before their |
| List | scheduled expiration date and should no longer be |
| | trusted |
| Common | A smart card used as the standard identification for |
| Access | Active Duty United States Defense personnel, to |
| Card | include the Selected Reserve and National Guard, |
| | United States Department of Defense (DOD) civilian |
| | employees, United States Coast Guard (USCG) civilian |
| | employees and eligible DOD and USCG contractor |
| | personnel. |
| | It is also the principal card used to enable physical |
| | access to buildings and controlled spaces, and it |
| | provides access to defense computer networks and |
| | systems. |
| Command | To compel or direct with authority (as opposed to a |
| | request, which is to express the need or desire) |
| Confiden- | Preserving authorized restrictions on information |
| tiality | access and disclosure, including means for protecting |
| | personal privacy and proprietary information, |
| Com- | A communication channel refers either to a physical |
| muni- | transmission medium such as a wire, or to a logical |
| cation | connection over a multiplexed medium such as a |
| Channel | radio channel in telecommunications and computer |
| | networking. |
| Critical | Security-related information (e.g., cryptographic keys, |
| Security | authentication data such as passwords and PINs) |
| Parameters | appearing in plaintext or otherwise unprotected form |
| | and whose disclosure or modification can compromise |
| | the security of a cryptographic module or the security |
| | of the information protected by the module. |
| CRL | See Certificate Revocation List |
| CSP | See Critical Security Parameter |
| Depart- | A federal department of the U.S. government |
| ment of | concerned with transportation and regulation thereof. |
| Trans- | For a given user input, the system will always produce |
| portation | the same output going through the same states |
| Deter- | |
| ministic | |
| DOD PKI | The DOD issues certificates to people and non-person |
| | entities (e.g., web listeners, network devices, routers, |
| | applications) to support DOD missions and business |
| | operations. On the Sensitive but Unclassified Internet |
| | Protocol Network (NIPRNet), the DOD PKI is a |
| | hierarchical system with a Root Certification Authority |
| | (CA) at the top of the hierarchy, and a number of |
| | issuing CAs that support scalability and provide |
| | disaster recovery capabilities. This PM issues |
| | certificates on Common Access Cards (CACs) as well |
| | as software certificates to support application needs. |
| | On the Secret Internet Protocol Network (SIPRNet), the |
| | DOD operates CAs under the National Security System |
| | (NSS) PKI Root CA, which supports all federal |
| | agencies that have users or systems on secret networks. |
| | The NSS PKI issues certificates on the SIPRNet |
| | hardware token as well as software certificates to |
| | support application needs. |
| | The DOD PKI and DOD portion of the NSS PKI are |
| | centralized infrastructures for the management of |
| | keys and certificates throughout their lifecycle |
| | (issuance through certificate revocation or expiration). |
| | These infrastructures support directory services which |
| | provide CA certificates, certificate revocation |
| | information, and user encryption certificates. |
| | See https://public.cybermil/pki-pke/ |
| DOT | See Department of Transportation |
| Encryption | The process of changing plaintext into ciphertext |
| | using a cryptographic algorithm and key. |
| ECA | See External Certification Authority |
| EMP | ElectroMagnetic Pulse, includes High Altitude EMP |
| | (HEMP) |
| External | The DOD has established the External Certification |
| Certifi- | Authority (ECA) program to support the issuance of |
| cation | DOD-approved certificates to industry partners and |
| Authority | other external entities and organizations who do not |
| | otherwise have access to DOD-approved PKI |
| | credentials. PKI certificates issued under the ECA |
| | program provide a mechanism for these entities to |
| | securely communicate with the DOD and authenticate |
| | to DOD Information Systems. The ECA PKI consists |
| | of a root CA maintained at the same facility that |
| | operates the DOD PKI Root CA, and subordinate CAs |
| | maintained by authorized vendors. More information |
| | on the ECA program can be found on the ECA |
| | Program page. |
| Federal | Publicly announced standards developed by the |
| Informa- | United States federal government for use in computer |
| tion | systems by non-military government agencies and |
| Processing | government contractors. |
| Standards | |
| Federal | A network of Certification Authorities (CAs) that issue: |
| PKI | • PIV credentials and person identity certificates |
| | • PIV-Interoperable credentials and person |
| | identity certificates |
| | • Other person identity certificates |
| | • A small number of federal enterprise device |
| | identity certificates |
| | The Federal PKI includes U.S. Federal, State, Local, |
| | Tribal, Territorial, and International Governments, as |
| | well as commercial organizations, that work together |
| | to provide services for the benefit of the Federal |
| | Government. |
| FIPS | See Federal Information Processing Standards |
| FIPS 140 | FIPS Standard for Security Requirements For |
| | Cryptographic Modules |
| FIPS 201 | A US Government Standard that specifies the |
| | architecture and technical requirements for a common |
| | identification standard for Federal employees and |
| | contractors. The overall goal is to achieve appropriate |
| | security assurance for multiple applications by |
| | efficiently verifying the claimed identity of individuals |
| | seeking physical access to Federally controlled |
| | government facilities and logical access to |
| | government information systems. The Standard |
| | contains the minimum requirements for a Federal |
| | personal identity verification system that meets the |
| | control and security objectives of Homeland Security |
| | Presidential Directive-12, including identity proofing, |
| | registration, and issuance. |
| GD | See Geomagnetic Disturbance |
| Geo- | A temporary disturbance of the Earth's |
| magnetic | magnetosphere caused by a solar wind shock wave |
| Distur- | and/or cloud of magnetic field that interacts with the |
| bance | Earth's magnetic field. |
| Global | The standard generic term for satellite navigation |
| Navigation | systems that provide autonomous geo-spatial |
| Satellite | positioning with global coverage. |
| System | |
| Global | The US Government's implementation of GNSS |
| Positioning | |
| System | |
| GPS | An XML schema designed as a common GPS data |
| Exchange | format for software applications. It can be used to |
| Format | describe waypoints, tracks, and routes. |
| GNSS | See Global Navigation Satellite System |
| GPS | See Global Positioning System |
| GPX | See GPS Exchange Format |
| HTTPS | Hypertext Transfer Protocol Secure |
| I&A | See Identification and Authentication |
| IAS | See Intrusion Analysis Software |
| Identifi- | The process of establishing and verifying the true |
| cation | identity of an entity interacting with a system, |
| and | |
| Authenti- | The process of establishing the true identity of an |
| cation | entity, |
| Identify | |
| Identity | A unique, auditable representation within the system, |
| | usually in the form of a simple character string for |
| | each individual user, machine, software component or |
| | any other entity. |
| | The identity can refer to a person or organization. |
| IEMI | See Intentional ElectroMagnetic Interference |
| illuminator | A device that concentrates or focuses. |
| Integrity | Guarding against improper information modification |
| | or destruction, and includes ensuring information |
| | authenticity. |
| Intentional | Intentional malicious generation of electromagnetic |
| Electro- | energy introducing noise or signals into electric and |
| Magnetic | electronic systems, thus disrupting, confusing or |
| Inter- | damaging these systems for terrorist or criminal |
| ference | purposes, |
| Jurisdiction | The geographical area in which an authority is |
| | recognized, |
| Keyhole | An extensible markup language (XML) notation for |
| Markup | expressing geographic annotation and visualization |
| Language | within two-dimensional maps. |
| KML | See Keyhole Markup Language |
| Law | Provides an interface to the public and coordinates |
| Enforce- | the response of law enforcement officers to crime and |
| ment | accident scenes. Additionally, performs management |
| Dispatch | and storage of critical data e.g., body and vehicle |
| | camera data. |
| Lawful | Refers to a situation where law enforcement may |
| Stop | legally command a vehicle to pull over and search |
| and | (inspect) the vehicle. |
| Search | |
| LE | See Law Enforcement Dispatch |
| Dispatch | |
| LSS | See Lawful Stop and Search |
| LIDAR | An acronym for Light Detection and Ranging, which |
| | is a remote sensing method that uses pulsed laser light |
| | to perform range measurements; it is and for control |
| | and navigation for autonomous vehicles. |
| Manifest | Referring to a cargo manifest, a document required |
| | identify the physical characteristics of a vehicle's |
| | cargo, such as cargo type, number, weight, and size. |
| | if the cargo contains dangerous goods, there may be |
| | a separate dangerous cargo manifest. |
| Modulate | The process of varying one or more properties of a |
| | periodic waveform, called the carrier signal, with a |
| | (modulating) signal that typically contains information |
| | to be transmitted. |
| National | A United States government non-regulatory federal |
| Institute of | agency Department of Commerce; its mission is to |
| Standards | promote US. innovation and industrial |
| and | competitiveness by advancing measurement science, |
| Tech- | standards, and technology in ways that enhance |
| nology | economic security and improve our quality of life. |
| NIST | See National Institute of Standards and Technology |
| Non- | For a given user input, the system may produce |
| determin- | different output because of outside influence that |
| istic | cannot be fully characterized |
| Non- | Assurance that the sender is provided with proof of |
| repudiation | delivery and that the recipient is provided with proof |
| | of the sender's identity so that neither can later deny |
| | having processed the data. Non-Repudiation requires |
| | record generation, collection, maintenance, |
| | availability and validation. Additionally, certificate |
| | management, protection, Non-repudiation of message |
| | exchange operations requires that the full security |
| | headers (including body signature and security token) |
| | of all messages MUST be written to audit trails at both |
| | NCP-A and NCP-B. |
| Non- | Non-repudiation of origin ensures that the originator |
| repudiation | of information cannot successfully deny having sent |
| of origin | the information. This requires a method to ensure that |
| | a subject that receives information during a data |
| | exchange is provided with evidence of the origin of |
| | the information. This evidence can then be verified by |
| | either this subject or other subjects, which requires he |
| | information be preserved e.g., audit trail. |
| Non- | Non-repudiation of receipt ensures that the recipient |
| repudiation | of information cannot successfully deny receiving the |
| of receipt | information. This requires a method to ensure that a |
| | subject that transmits information during a data |
| | exchange is provided with evidence of receipt of the |
| | information. This evidence can then be verified by |
| | either this subject or other subjects, which requires he |
| | information be preserved e.g., audit trail. |
| Personal | A common identification standard for Federal |
| Identity | employees and contractors specified by FIPS 201 |
| Verifi- | |
| cation | |
| OCSP | See Online Certificate Status Protocol |
| Online | An Internet protocol used for obtaining the revocation |
| Certificate | status of an X.509 digital certificate as described in |
| Status | RFC 6960. |
| Protocol | |
| PIV | See Personal Identity Verification |
| PPD-21 | Presidential Policy Directive (PPD) on Critical |
| | Infrastructure Security and Resilience |
| PKE | See Public Key Enablement |
| Public Key | The process of ensuring that applications can use |
| Enable- | certificates issued by a PKI to support identification |
| ment | and authentication, data integrity, confidentiality |
| | and/or technical non-repudiatiom Common use cases |
| | include enabling: |
| | • Smart card logon to DOD networks and |
| | certificate-based authentication to systems |
| | • Secure connections (SSL/TLS) to DOD listeners |
| | • Digital signature and encryption of emails from |
| | desktop, web, and mobile initiators |
| | • Digital signature of forms |
| PKI | See |
| Public Key | A framework established to issue, maintain, and |
| Infra- | revoke public key certificates, including systems, |
| structure | processes and people. Public key certificates provide |
| | digital signature and encryption capabilities, which |
| | can be used to implement the following security |
| | services: |
| | • Identification and Authentication: PKI provides |
| | for identification and authentication through |
| | digital signature. If the signature is valid, then |
| | the Relying Party (the person or system relying |
| | on the presented certificate for authentication |
| | or other security services) has assurance that |
| | the entity participating in the transaction is the |
| | Subscriber (the identity asserted by the |
| | certificate). |
| | • Data Integrity: PKI provides for data integrity |
| | through digital signature of information. If the |
| | recipient of digitally signed information is able |
| | to verify the signature on the information using |
| | the public key of the certificate used to |
| | generate the signature, then the recipient |
| | knows that the content has not changed since it |
| | was signed. |
| | • Confidentiality: PKI provides confidentiality |
| | through encryption. If the public key in a |
| | certificate is used to encrypt information, only |
| | the associated private key, held (and kept |
| | secret) by the entity named in the certificate, |
| | can decrypt that information. |
| | • Technical Non-Repudiation: PKI assists with |
| | technical non-repudiation through digital |
| | signatures. Technical non-repudiation can be |
| | considered a form of attribution, namely that |
| | the digitally signed information can be |
| | attributed to the entity identified in the |
| | certificate used to generate the signature. |
| SAE | Society of Automotive Engineers |
| Request | A publication from the Internet Society (ISOC) and its |
| for | associated bodies, most prominently the Internet |
| Comment | Engineering Task Force (IETF), the principal technical |
| | development and standards-setting bodies for the |
| | Internet. |
| | The official source for RFCs on the World Wide Web |
| | is the RFC Editor. Almost any published RFC can be |
| | retrieved via a URL of the form http://www.rfc- |
| | editor.org/rfc/rfcNNNN.txt, shown for RFC NNNN |
| RFC | See Request for Comment, |
| SAE | Automated system issues warnings and may |
| Autonomy | momentarily intervene but has no sustained vehicle |
| Level 0 | control. |
| SAE | Driver and automated system shares control over the |
| Autonomy | vehicle. An example would be Adaptive Cruise Control |
| Level 1 | (ACC) where the driver controls steering and the |
| | automated system controls speed. Using Parking |
| | Assistance, steering is automated while speed is |
| | manual. The driver must be ready to retake full |
| | control at any time. |
| SAE | The automated system takes full control of the |
| Autonomy | vehicle accelerating, braking, and steering. The driver |
| Level 2 | must monitor the driving and be prepared to |
| | immediately intervene at any time if the automated |
| | system fails to respond properly. |
| SAE | The driver can safely turn their attention away from |
| Autonomy | the driving tasks, e.g. the driver can text or watch a |
| Level 3 | movie. The vehicle will handle situations that call for |
| | an immediate response, like emergency braking. The |
| | driver must still be prepared to intervene within some |
| | limited time when called upon by the vehicle to do so |
| | (specified by the manufacturer). |
| SAE | As level 3, but no driver attention is ever required for |
| Autonomy | safety, i.e. the driver may safely go to sleep or leave |
| Level 4 | the driver's seat. Self driving is supported only in |
| | limited areas or under special circumstances, like |
| | traffic jams. Outside of these areas or circumstances, |
| | the vehicle must be able to safely abort the trip, i.e. |
| | park the car, if the driver does not retake control. |
| SAE | No human intervention is required. e.g., robotic taxi. |
| Autonomy | |
| Level 5 | |
| Secure | A cryptographic network protocol for operating |
| Shell | network services securely over an unsecured |
| | network. Typical applications include remote |
| | command-line, login, and remote command |
| | execution; any network service can be secured with |
| | SSH |
| SSH | See Secure Shell |
| Truck | A principal use of land or building where there are |
| Terminal | dock facilities for trucks, either partially enclosed or |
| | unenclosed, for the purposes of transferring goods or |
| | breaking down and assembling tractor-trailer |
| | transport. |
| | Aa building or property used as an origin or |
| | destination point for the loading, unloading, |
| | assembling or transferring of goods transported by |
| | truck, or which provides containerized freight handling |
| | facilities or rail-truck services, and where the local |
| | pickup, delivery and transitory storage of goods is |
| | incidental to the primary function of motor freight |
| | shipment, provided, however, that any lot where |
| | trucking is the principal use and which operates any |
| | vehicles in excess of single unit, single axle, 13,600 |
| | kg GVW (29,982.36 lbs. GVW) (Gross Vehicle |
| | Weight) shall be considered for the purpose of this |
| | Bylaw, as a truck terminal. |
| Vehicle | A means of carrying or transporting something, |
| | e.g.,planes, trains, automobile, or piece of |
| | mechanized equipment, |
| Vehicle | Vehicle dispatch plays a major role in transportation |
| Dispatch | logistics, referring to commercial dispatchers that |
| | orchestrates freight movement and equipment from |
| | one place to another while keeping close |
| | communication with vehicles. Communication may be |
| | implemented via Internet, mobile radio, or other |
| | means as design dictates. Vehicle dispatch can refer |
| | to any base of operations of the entity controlling, |
| | operating, or owning the vehicle where vehicle |
| | records are maintained, including audit information |
| | sent from the vehicle override controller. |
| V2I | Vehicle to Infrastructure |
| V2V | Vehicle to Vehicle |
| V2X | V2I and V2V |

What is claimed is:

1. A Lawful Stop and Search (LSS) system for the external management of an autonomous vehicle under control of an Automatic Driving System (ADS) comprising:
a plurality of Law Stop and Search (LSS) external controllers;
a plurality of LSS audit servers including a Law Enforcement Audit Server and a vehicle dispatch audit server; and
a LSS override controller configured to communicate with said plurality of LSS external controllers and said plurality of LSS audit servers.

2. The LSS Override Controller of claim 1, wherein said LSS override controller is further configured to receive a command message from one of said LSS external controllers, evaluate the command message for validity, and if valid, execute the command message to override ADS control.

3. The LSS Override Controller of claim 1, wherein said LSS Override Controller is further configured to independently monitor the behavior, enforce operational limitations, record audit records of attempts to exceed any operational limitation, and record audit records of hardware or software failures, of said ADS controller.

4. The LSS Override Controller of claim 1, wherein the controller employs a Point-to-Point (PPP) communication link protocol between the LSS Override Controller and the LSS External Controllers that includes at least one of the following characteristics: message confidentiality, message integrity, end-point mutual authentication, reliability, non-repudiation, and perfect forward secrecy.

5. The LSS Override Controller of claim 1, wherein the controller employs Transport Layer Security (TLS) over Transport Control Protocol/Internet Protocol (TCP/IP) to secure communications between the LSS Override Controller and LSS Audit Servers that includes at least one of the following characteristics: message confidentiality, message integrity, end-point mutual authentication, guaranteed message delivery, non-repudiation, and perfect forward secrecy.

6. The LSS External Controllers of claim 1, wherein said controllers include one or more of:
a LSS Controller comprising:
a LSS manual controller,
a LSS illuminator comprising:
a LSS Handheld Illuminator,
a LSS Automobile Mounted illuminator,
a LSS Helicopter Mounted illuminator; and
a LSS Fence; and
a LSS special function controller comprising:
a LSS special function manual controller comprising:
a LSS Terminal Controller, and
a LSS Maintenance Controller; and
a LSS special function illuminator, comprising:
a LSS Emergency Vehicle Controller, and
a LSS Location Controller.

7. The LSS Override Controller of claim 1, wherein said controller includes a smart card reader and a Personal Identification Number (PIN) input device to support dual factor authentication of the administrative entity.

8. The LSS external controllers of claim 1, wherein said controllers includes a smart card reader and a Personal Identification Number (PIN) input device to support dual factor authentication of the using entity.

9. The LSS Illuminator of claim 6, wherein said illuminator includes a camera and pointing aid physically aligned on the signaling beam axis of said illuminator.

10. A system for the external management of a mechanism under control of an Artificial Intelligence (AI) based controller comprising:
one or more external controllers;
one or more audit servers; and
an override controller configured to:
communicate with the one or more external controllers and the one or more audit servers.

11. The override controller of claim 10, wherein the override controller is further configured to receive a command message from one of said external controllers, evaluate the command message for validity, and if valid, execute the command message to assert unconditional control over the AI-based controller and controlled mechanism.

12. The override controller of claim 10, wherein the controller is further configured to:
independently monitor the behavior, enforce operational limitations, record audit records of attempts to exceed any operational limitation, and record audit records of hardware or software failures, of the AI-based controller and said mechanism.

13. A system for the control and management of a mechanism comprising:
an AI-based controller employing neural networks and machine learning algorithms to control said mechanism;
a deterministic override controller that can assert unconditional control over the AI-based controller and said mechanism;
one or more external controllers; and
one or more audit servers.

14. The override controller of claim 13, wherein the override controller is configured to receive operational rules and operational limitations from one of said external controllers.

15. The override controller of claim 13, wherein the override controller is further configured to independently monitor the behavior, enforce operational limitations, record audit records of attempts to exceed any operational limitation, and record audit records of hardware or software failures, of the AI-based controller and said mechanism.

16. The override controller of claim 13, wherein the override controller is further configured to receive a command message from one of said external controllers, evaluate the command message for validity, and if valid, execute the command message to assert unconditional control over the AI-based controller and controlled mechanism.

17. The override controller of claim 13, wherein the override controller executes as part of the hypervisor layer and controls all access to hardware resources including the controlled mechanism, processing resources, memory, and communications, including LAN and WAN endpoints.

18. The AI-based controller of claim 13, wherein the AI-based controller executes as part of the application layer and is dependent on the hypervisor layer for all access to hardware resources.
